(19) United States
(12) Patent Application Publication
(10) Pub. No.: US 2026/0292781 A1
(43) Pub. Date: Sep. 24, 2026

(54) INFORMATION PROCESSING APPARATUS AND INFORMATION PROCESSING METHOD

(71) Applicant: SONY GROUP CORPORATION, TOKYO (JP)

(72) Inventors: KENTA ASAKURA, TOKYO (JP); Hao Wang, TOKYO (JP); Jungo Goto, TOKYO (JP)

(21) Appl. No.: 18/874,164

(22) PCT Filed: Jun. 2, 2023
(86) PCT No.: PCT/JP2023/020606

§ 371 Date: Dec. 12, 2024

(30) Foreign Application Priority Data
Jun. 20, 2022 (JP) 2022-098677

(51) Int. Cl. H04W 64/00; H04B 17/318; H04W 4/024

(52) U.S. Cl. CPC H04W 64/006; H04B 17/328; H04W 4/024

(57) ABSTRACT

An information processing apparatus includes: an acquisition unit that acquires information of a geographical position; and an output control unit that outputs direction information indicating a direction in which radio field intensity increases in a case where wireless connection using a predetermined frequency band is performed at the geographical position.

### FIELD

The present disclosure relates to an information processing apparatus and an information processing method.

### BACKGROUND

Communication apparatuses using radio waves in a high frequency band have been actively developed. For example, in recent years, communication apparatuses using radio waves in the millimeter wave band or the quasi-millimeter wave band have been actively developed.

### CITATION LIST

### Patent Literature

Patent Literature 1: JP 2021-132241 A

### SUMMARY

### Technical Problem

Radio waves in a high frequency band have a characteristic that rectilinearity is strong and diffraction is weak. Therefore, in wireless communication using radio waves in a high frequency band, surrounding obstacles greatly affect communication quality. For example, in the millimeter wave band and the quasi-millimeter wave band, since a human body is also an obstacle, even in wireless communication at the same position, a large difference occurs in communication quality depending on an angle at which the radio wave is received.

Therefore, the present disclosure proposes an information processing apparatus and an information processing method capable of realizing wireless communication of high communication quality.

Note that the above problem or object is merely one of a plurality of problems or objects that can be solved or achieved by the plurality of embodiments disclosed in the present specification.

### Solution to Problem

In order to solve the above problem, an information processing apparatus according to one embodiment of the present disclosure includes: an acquisition unit that acquires information of a geographical position; and an output control unit that outputs direction information indicating a direction in which radio field intensity increases in a case where wireless connection using a predetermined frequency band is performed at the geographical position.

### BRIEF DESCRIPTION OF DRAWINGS

FIG. 1 is a diagram for explaining an outline of the present embodiment.

FIG. 2 is a diagram illustrating a configuration example of a communication system according to an embodiment of the present disclosure.

FIG. 3 is a diagram illustrating a configuration example of a communication system in a case where one of networks is a cellular network.

FIG. 4 is a diagram illustrating a configuration example of a server according to an embodiment of the present disclosure.

FIG. 5 is a diagram illustrating a configuration example of a management apparatus according to an embodiment of the present disclosure.

FIG. 6 is a diagram illustrating a configuration example of a base station according to an embodiment of the present disclosure.

FIG. 7 is a diagram illustrating a configuration example of a terminal apparatus according to an embodiment of the present disclosure.

FIG. 8 is a sequence diagram illustrating an example of information collection processing.

FIG. 9 is a sequence diagram illustrating an example of heat map providing processing.

FIG. 10 is a flowchart illustrating an example of heat map generation processing.

FIG. 11 is a diagram for explaining division processing of a heat map creation area.

FIG. 12 is a diagram illustrating a state in which a display indicating radio field intensity and direction information is added to each cell.

FIG. 13 is a diagram for explaining calculation processing of direction information.

FIG. 14 is a diagram for explaining calculation processing of direction information.

FIG. 15 is a diagram for explaining calculation processing of direction information.

FIG. 16 is a diagram illustrating an example of a heat map according to a first modification.

FIG. 17 is a diagram illustrating another example of the heat map according to the first modification.

FIG. 18 is a diagram illustrating an example of a heat map according to a second modification.

FIG. 19 is a diagram illustrating an example of a heat map according to a third modification.

FIG. 20 is a diagram illustrating an example of a heat map according to a fourth modification.

FIG. 21 is a diagram illustrating an example of a heat map according to the fourth modification.

FIG. 22 is a diagram illustrating an example of a heat map according to a fifth modification.

FIG. 23 is a diagram illustrating an example of route display according to the fifth modification.

FIG. 24 is a diagram illustrating an example of a heat map according to a sixth modification.

FIG. 25 is a diagram illustrating an example of a heat map according to a seventh modification.

FIG. 26 is a diagram illustrating an example of base station position display according to the seventh modification.

### DESCRIPTION OF EMBODIMENTS

Hereinafter, embodiments of the present disclosure will be described in detail with reference to the drawings. Note that, in each of the following embodiments, the same parts are denoted by the same reference signs, and redundant description will be omitted.

In addition, in the present specification and the drawings, a plurality of components having substantially the same functional configuration may be distinguished by attaching different numerals after the same reference signs. For example, a plurality of configurations having substantially the same functional configuration is distinguished as terminal apparatuses 401, 402, and 403 as necessary. However, in a case where it is not particularly necessary to distinguish each of a plurality of components having substantially the same functional configuration, only the same reference sign is attached. For example, in a case where it is not necessary to particularly distinguish the terminal apparatuses 401, 402, and 403, they are simply referred to as terminal apparatuses 40.

One or more embodiments (examples and modifications) described below can each be implemented independently. Meanwhile, at least some of the plurality of embodiments described below may be appropriately combined with at least some of other embodiments. The plurality of embodiments may include novel features different from each other. Therefore, the plurality of embodiments can contribute to solving different objects or problems, and can exhibit different effects.

### 1. OUTLINE

Communication apparatuses using radio waves in a high frequency band have been actively developed. For example, in recent years, communication apparatuses using radio waves (for example, a radio wave in a millimeter wave band) having a frequency of 28 GHz or more have been actively developed. Here, the millimeter wave band is, for example, a band of 30 GHz to 300 GHz. The “millimeter wave band” appearing in the following description can be appropriately replaced with a quasi-millimeter wave band (for example, 20 GHz to 30 GHz band). In addition, the high frequency band can be appropriately replaced with a “millimeter wave band” or a “quasi-millimeter wave band”.

Radio waves in a high frequency band have a characteristic that rectilinearity is strong and diffraction is weak. Therefore, in wireless communication using radio waves in a high frequency band, surrounding obstacles greatly affect communication quality. For example, in a radio wave (for example, a radio wave in a millimeter wave band) in a frequency band of 28 GHz or more, since a human body is also an obstacle, even in wireless communication at the same position, a large difference occurs in communication quality depending on an angle at which the radio wave is received.

In order for a user to stably use wireless communication using radio waves in a high frequency band, it is desirable to enable the user to understand at which position and in which direction the communication apparatus should receive radio waves.

Therefore, the present embodiment solves the above problem as follows.

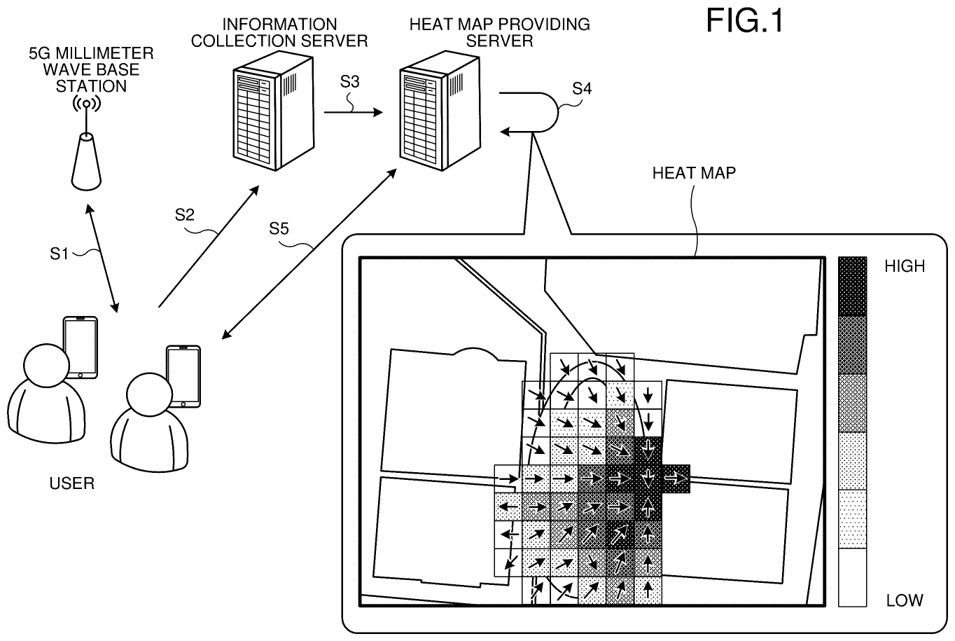

FIG. 1 is a diagram for explaining an outline of the present embodiment.

First, when a terminal apparatus used by a user starts wireless connection with a base station, the terminal apparatus starts acquiring information regarding the wireless connection. In the example of FIG. 1, the base station is a millimeter wave base station, and the terminal apparatus acquires information regarding millimeter wave communication (step S1). Here, the information regarding the wireless connection acquired by the terminal apparatus is, for example, time information (for example, time information at the time of millimeter wave connection) at the time of wireless connection, position information, radio field intensity information, and information in the terminal direction when the radio field intensity is observed.

Next, an information collection server collects information regarding wireless connection from a plurality of terminal apparatuses (step S2). Then, a heat map providing server acquires the collected information from the information collection server (step S3). At this time, the heat map providing server may add weighting information to the data in consideration of characteristics of the millimeter wave and the quasi-millimeter wave that are easily affected by a change in the surrounding environment so as to emphasize new collected information.

The heat map providing server creates a heat map as illustrated in FIG. 1, for example, by statistically processing the information from the information collection server (step S4). The heat map is a map in which a display indicating radio field intensity in communication in a high frequency band and a display indicating a terminal direction optimal for reception of a radio wave in the band are displayed in a superimposed manner on the map for each point on the map. In the example of FIG. 1, each of a plurality of lattice-shaped cells is a point on the map. The thicker the hatch attached to the cell, the stronger the radio field intensity. Further, a direction indicated by an arrow in a cell indicates a terminal direction optimal for reception of a radio wave.

The user displays the heat map on the terminal apparatus by accessing the heat map providing server (step S5).

As a result, the user can determine at which position and in which direction the terminal apparatus should be directed without prior measurement by the terminal apparatus at the time of wireless communication using the high frequency band. Furthermore, the user can obtain relatively latest information regarding a communication environment in a high frequency band that is easily affected by a change in the surrounding environment. As a result, the information processing apparatus (for example, an information processing apparatus or a terminal apparatus) can assist the user in establishing a wireless connection using the high frequency band.

Note that the position information of the base station is confidential information that is not desired to be made public by the operator. In the present embodiment, the information processing apparatus displays not the position itself of the base station but information on a direction in which the radio field intensity is calculated to be high from a plurality of points in a certain area. As a result, the information processing apparatus according to the present embodiment can indicate, to the user, in which direction the terminal is directed to improve the radio quality while maintaining the position information of the base station in a secret state.

The outline of the present embodiment has been described above, and a communication system 1 according to the present embodiment will be described in detail below.

### 2. CONFIGURATION OF COMMUNICATION SYSTEM

First, a configuration of the communication system 1 will be described.

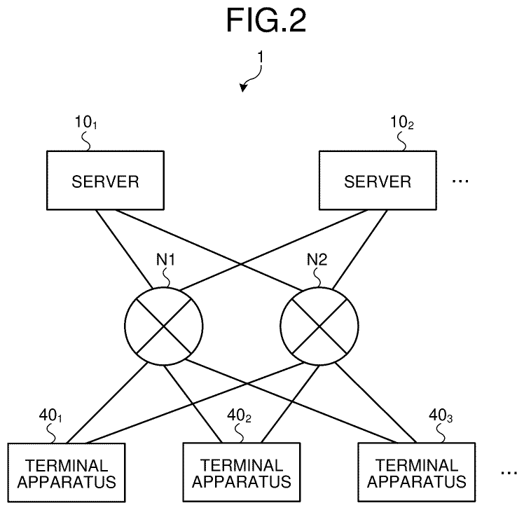

FIG. 2 is a diagram illustrating a configuration example of the communication system 1 according to the embodiment of the present disclosure. The communication system 1 includes a server 10 and a terminal apparatus 40. The communication system 1 may include a plurality of servers 10 and a plurality of terminal apparatuses 40. In the example of FIG. 2, the communication system 1 includes servers 101, 102, and the like as the server 10, and includes terminal apparatuses 401, 402, 403, and the like as the terminal apparatus 40. The terminal apparatus 40 may be configured to be connectable to a plurality of networks. In the example of FIG. 2, the terminal apparatus 40 is configured to be connectable to a network N1 and a network N2. The terminal apparatus 40 is connected to the server 10 via the network N1 or the network N2.

The networks N1 and N2 are, for example, communication networks such as a local area network (LAN), a wide area network (WAN), a cellular network, a fixed telephone network, a regional Internet protocol (IP) network, and the Internet. The networks N1 and N2 may include a wired network or a wireless network. In addition, the networks N1 and N2 may include a core network. The core network is, for example, an evolved packet core (EPC) or a 5G core network (5GC). Of course, the network N may be a data network connected to the core network. The data network may be a service network of a communication operator, for example, an IP multimedia subsystem (IMS) network. Furthermore, the data network may be a private network such as an intra-company network.

Note that, although only two networks are illustrated in the example of FIG. 2, the number of networks is not limited to two. For example, the network to which the terminal apparatus 40 can be connected may be a plurality of cellular networks with different communication operators and a wireless LAN network (for example, Wi-Fi (registered trademark)). Of course, there may be one network.

The terminal apparatus 40 may be connectable to a network using one communication path or may be connectable to a network using a plurality of communication paths. At this time, at least one of the one or more communication paths may be a wireless communication path. For example, the communication path may be a wireless communication path (radio access network) between the terminal apparatus 40 and a base station. Furthermore, the communication path may be a wireless communication path between the terminal apparatus 40 and an access point. Of course, the plurality of communication paths may include a wired communication path (for example, a wired LAN). Note that the communication path may be a network itself.

In a case where a wireless communication path is included in one or more communication paths, the terminal apparatus 40 may be configured to connect to a network using a radio access technology (RAT) such as long term evolution (LTE), new radio (NR), Wi-Fi, or Bluetooth (registered trademark). At this time, the terminal apparatus 40 may be configured to be able to use different radio access technologies (wireless communication schemes). For example, the terminal apparatus 40 may be configured to be able to use NR and Wi-Fi. Furthermore, the terminal apparatus 40 may be configured to be able to use different cellular communication technologies (for example, LTE and NR). LTE and NR are a type of cellular communication technology, and enable mobile communication of a terminal apparatus by arranging a plurality of areas covered by base stations in cell shapes.

Note that, in the following description, “LTE” includes LTE-Advanced (LTE-A), LTE-Advanced Pro (LTE-A Pro), and Evolved Universal Terrestrial Radio Access (EUTRA). In addition, the NR includes New Radio Access Technology (NRAT) and Further EUTRA (FEUTRA). Note that a single base station may manage a plurality of cells. In the following description, a cell corresponding to LTE is referred to as an LTE cell, and a cell corresponding to NR is referred to as an NR cell.

NR is a radio access technology of a next generation (fifth generation) of LTE (fourth generation communication including LTE-Advanced and LTE-Advanced Pro). The NR is a radio access technology that can support various use cases including enhanced mobile broadband (eMBB), massive machine type communications (mMTC), and ultra-reliable and low latency communications (URLLC). NR has been studied aiming at a technical framework corresponding to usage scenarios, requirement conditions, arrangement scenarios, and the like in these use cases.

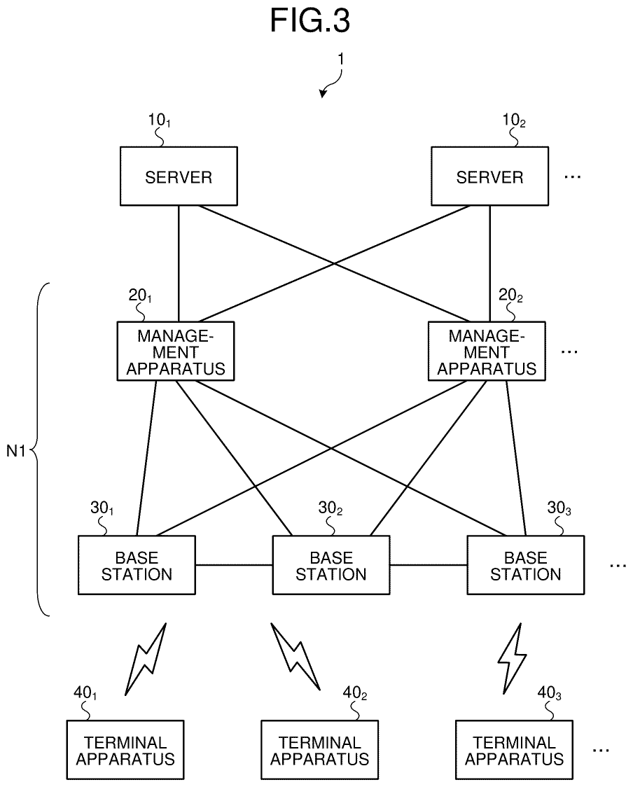

FIG. 3 is a diagram illustrating a configuration example of the communication system 1 in a case where one of the networks is a cellular network. In the example of FIG. 3, the network N1 is a cellular network. The communication system 1 includes a server 10, a management apparatus 20, a base station 30, and a terminal apparatus 40. The communication system 1 illustrated in FIG. 3 provides the user with a wireless network capable of mobile communication by the wireless communication apparatuses constituting the communication system 1 operating in cooperation. The wireless network of the present embodiment includes, for example, a radio access network and a core network. Note that, in the present embodiment, the wireless communication apparatus is an apparatus having a function of wireless communication, and corresponds to the base station 30 and the terminal apparatus 40 in the example of FIG. 3. In the following description, the wireless communication apparatus may be simply referred to as a communication apparatus.

The communication system 1 may include a plurality of servers 10, a plurality of management apparatuses 20, a plurality of base stations 30, and a plurality of terminal apparatuses 40. In the example of FIG. 3, the communication system 1 includes servers 101, 102, and the like as the server 10, and management apparatuses 201, 202, and the like as the management apparatus 20. Furthermore, the communication system 1 includes base stations 301, 302, and the like as the base station 30, and includes terminal apparatuses 401, 402, 403, and the like as the terminal apparatus 40.

Note that the base station 30 constituting the communication system 1 may be a ground station or a non-ground station. The non-ground station may be a satellite station or an aircraft station. If the non-ground station is a satellite station, the communication system 1 may be a Bent-pipe (Transparent) type mobile satellite communication system.

Note that, in the present embodiment, the ground station (also referred to as a ground base station) refers to a base station (including a relay station) installed on the ground. Here, the “ground” is a ground in a broad sense including not only on land but also underground, on water, and underwater. Note that, in the following description, the description of “ground station” may be replaced with “gateway”.

Note that an LTE base station may be referred to as an evolved node B (eNodeB) or an eNB. Further, an NR base station may be referred to as a gNodeB or a gNB. In addition, in LTE and NR, a terminal apparatus (also referred to as a mobile station or a terminal) may be referred to as user equipment (UE). Note that the terminal apparatus 40 is a type of communication apparatus, and is also referred to as a mobile station or a terminal.

Note that the terminal apparatus 40 may be connectable to a network using a radio access technology (wireless communication scheme) other than LTE, NR, Wi-Fi, and Bluetooth. For example, the terminal apparatus 40 may be connectable to a network by using low power wide area (LPWA) communication. Furthermore, the terminal apparatus 40 may be connectable to a network using wireless communication of a proprietary standard.

Here, LPWA communication is wireless communication that enables low-power wide-range communication. For example, the LPWA radio is Internet of Things (IoT) wireless communication using specific low power radio (for example, the 920 MHz band) or an industry-science-medical (ISM) band. Note that the LPWA communication used by the terminal apparatus 40 may conform to the LPWA standard. Examples of the LPWA standard include ELTRES, ZETA, SIGFOX, LoRaWAN, and NB-Iot. Of course, the LPWA standard is not limited thereto, and may be other LPWA standards.

Note that one or more communication paths may include a virtual network. For example, the plurality of communication paths to which the terminal apparatus 40 can be connected may include a virtual network such as a virtual local area network (VLAN) and a physical network such as an IP communication path. In this case, the terminal apparatus 40 may perform the route control on the basis of a route control protocol such as Open Shortest Path First (OSPF) or Border Gateway Protocol (BGP).

In addition, the plurality of communication paths may include a plurality of one or more overlay networks or one or more network slicing.

Note that the apparatuses in the drawings may be considered as apparatuses in a logical sense. That is, a part or all of the apparatuses in the drawing may be realized by a virtual machine (VM), a container, a docker, or the like, and they may be implemented on physically the same hardware.

Hereinafter, a configuration of each apparatus constituting the communication system 1 will be specifically described. Note that the configuration of each apparatus described below is merely an example. The configuration of each apparatus may be different from the following configuration.

### <2-1. Configuration of Server>

First, a configuration of the server 10 will be described.

The server 10 is an information processing apparatus (computer) that provides various services to the terminal apparatus 40 via a network (for example, networks N1 and N2). For example, the server 10 may be an information collection server or a heat map providing server. The information collection server is a server that collects information regarding creation of a heat map. The heat map providing server is a server that creates a heat map and provides the heat map to the user. The information collection server and the heat map providing server may be configured by one server.

Note that the server 10 is not limited to the above-described server. For example, the server 10 may be an application server or a Web server. The server 10 may be a PC server, a midrange server, or a mainframe server. Furthermore, the server 10 may be an information processing apparatus that performs data processing (edge processing) near the user or the terminal. For example, the server 10 may be an information processing apparatus (computer) provided side by side with or built in the base station. Of course, the server 10 may be an information processing apparatus that performs cloud computing.

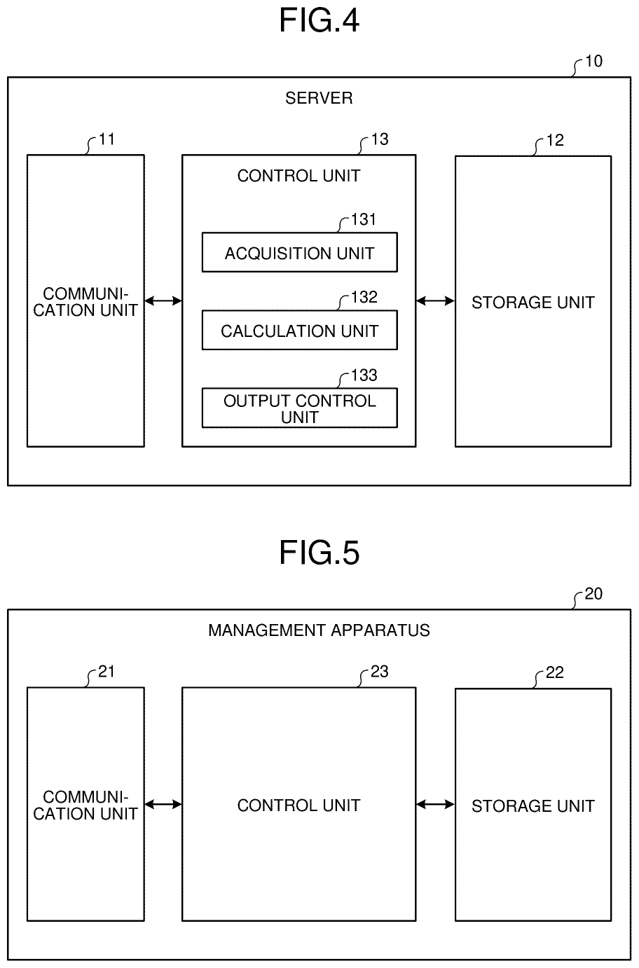

FIG. 4 is a diagram illustrating a configuration example of the server 10 according to the embodiment of the present disclosure. The server 10 includes a communication unit 11, a storage unit 12, and a control unit 13. Note that the configuration illustrated in FIG. 4 is a functional configuration, and the hardware configuration may be different from the functional configuration. Furthermore, the functions of the server 10 may be implemented in a distributed manner in a plurality of physically separated configurations. For example, the server 10 may include a plurality of information processing apparatuses.

The communication unit 11 is a communication interface for communicating with other apparatuses. For example, the communication unit 11 is a network interface. For example, the communication unit 11 is a local area network (LAN) interface such as a network interface card (NIC). Note that the communication unit 11 may be a wired interface or a wireless interface. The communication unit 11 functions as a communication means of the server 10. The communication unit 11 communicates with the terminal apparatus 40 under the control of the control unit 13.

The storage unit 12 is a data readable/writable storage apparatus such as a dynamic random access memory (DRAM), a static random access memory (SRAM), a flash memory, or a hard disk. The storage unit 12 functions as a storage means of the server 10. The storage unit 12 stores, for example, a prediction model (learning model) to be distributed to the terminal apparatus 40, such as a quality prediction model and an intention prediction model. These pieces of information will be described later.

The control unit 13 is a controller that controls each unit of the server 10. The control unit 13 is realized by, for example, a processor such as a central processing unit (CPU) or a micro processing unit (MPU). For example, the control unit 13 is implemented by a processor executing various programs stored in a storage apparatus inside the server 10 using a random access memory (RAM) or the like as a work area. Note that the control unit 13 may be realized by an integrated circuit such as an application specific integrated circuit (ASIC) or a field programmable gate array (FPGA). Any of the CPU, the MPU, the ASIC, and the FPGA can be regarded as a controller.

As illustrated in FIG. 4, the control unit 13 includes an acquisition unit 131, a calculation unit 132, and an output control unit 133. Each block (the acquisition unit 131 to the output control unit 133) constituting the control unit 13 is a functional block indicating a function of the control unit 13. These functional blocks may be software blocks or hardware blocks. For example, each of the functional blocks described above may be one software module realized by software (including microprograms), or may be one circuit block on a semiconductor chip (die). Of course, each functional block may be one processor or one integrated circuit. A configuration method of the functional block is arbitrary. Note that the control unit 13 may be configured by functional units different from the above-described functional blocks. The operation of the control unit 13 may be the same as the operation of each block of the control unit 43 of the terminal apparatus 40.

### <2-2. Configuration of Management Apparatus>

Next, a configuration of the management apparatus 20 will be described.

The management apparatus 20 is an apparatus that manages a wireless network. For example, the management apparatus 20 is an apparatus that manages communication of the base station 30. The management apparatus 20 may be, for example, an apparatus having a function as a mobility management entity (MME). The management apparatus 20 may be an apparatus having a function as an access and mobility management function (AMF) and/or a session management function (SMF). Of course, the functions of the management apparatus 20 are not limited to the MME, the AMF, and the SMF. The management apparatus 20 may be an apparatus having a function as a network slice selection function (NSSF), an authentication server function (AUSF), a policy control function (PCF), or a unified data management (UDM). Furthermore, the management apparatus 20 may be an apparatus having a function as a home subscriber server (HSS).

Note that the management apparatus 20 may have a function of a gateway. For example, the management apparatus 20 may have a function as a serving gateway (S-GW) or a packet data network gateway (P-GW). Furthermore, the management apparatus 20 may have a function as a user plane function (UPF).

The core network includes a plurality of network functions, and each network function may be aggregated into one physical apparatus or distributed to a plurality of physical apparatuses. That is, the management apparatus 20 can be dispersedly arranged in a plurality of apparatuses. Further, this distributed arrangement may be controlled to be performed dynamically. The base station 30 and the management apparatus 20 constitute one network, and provide a wireless communication service to the terminal apparatus 40. The management apparatus 20 is connected to the Internet, and the terminal apparatus 40 can use various services provided via the Internet via the base station 30.

Note that the management apparatus 20 is not necessarily an apparatus constituting the core network. For example, it is assumed that the core network is a core network of wideband code division multiple access (W-CDMA) or code division multiple access 2000 (cdma2000). At this time, the management apparatus 20 may be an apparatus that functions as a radio network controller (RNC).

FIG. 5 is a diagram illustrating a configuration example of the management apparatus 20 according to the embodiment of the present disclosure. The management apparatus 20 includes a communication unit 21, a storage unit 22, and a control unit 23. Note that the configuration illustrated in FIG. 5 is a functional configuration, and the hardware configuration may be different from the functional configuration. Furthermore, the functions of the management apparatus 20 may be statically or dynamically distributed and implemented in a plurality of physically separated configurations. For example, the management apparatus 20 may include a plurality of server apparatuses.

The communication unit 21 is a communication interface for communicating with other apparatuses. The communication unit 21 may be a network interface or a device connection interface. For example, the communication unit 21 may be a local area network (LAN) interface such as a network interface card (NIC), or may be a USB interface including a universal serial bus (USB) host controller, a USB port, and the like. Furthermore, the communication unit 21 may be a wired interface or a wireless interface. The communication unit 21 functions as a communication means of the management apparatus 20. The communication unit 21 communicates with the base station 30 and the like under the control of the control unit 23.

The storage unit 22 is a data readable/writable storage apparatus such as a dynamic random access memory (DRAM), a static random access memory (SRAM), a flash memory, or a hard disk. The storage unit 22 functions as a storage means of the management apparatus 20. The storage unit 22 stores, for example, a connection state of the terminal apparatus 40. For example, the storage unit 22 stores a radio resource control (RRC) state or an EPS connection management (ECM) state or a 5G system connection management (CM) state of the terminal apparatus 40. The storage unit 22 may function as a home memory that stores the position information of the terminal apparatus 40.

The control unit 23 is a controller that controls each unit of the management apparatus 20. The control unit 23 is realized by, for example, a processor such as a central processing unit (CPU), a micro processing unit (MPU), or a graphics processing unit (GPU). For example, the control unit 23 is realized by the processor executing various programs stored in the storage apparatus inside the management apparatus 20 using a random access memory (RAM) or the like as a work area. Note that the control unit 23 may be realized by an integrated circuit such as an application specific integrated circuit (ASIC) or a field programmable gate array (FPGA). Any of the CPU, the MPU, the GPU, the ASIC, and the FPGA can be regarded as a controller.

### <2-3. Configuration of Base Station>

Next, a configuration of the base station 30 will be described.

The base station 30 is a wireless communication apparatus that performs wireless communication with the terminal apparatus 40. The base station 30 may be configured to wirelessly communicate with the terminal apparatus 40 via a relay station, or may be configured to directly wirelessly communicate with the terminal apparatus 40.

The base station 30 is a type of communication apparatus. More specifically, the base station 30 is an apparatus corresponding to a wireless base station (Base Station, Node B, eNB, gNB, or the like) or a wireless access point. The base station 30 may be a wireless relay station. Furthermore, the base station 30 may be an optical extension apparatus called a remote radio head (RRH) or a radio unit (RU). Furthermore, the base station 30 may be a receiving station such as a field pickup unit (FPU). Furthermore, the base station 30 may be an integrated access and backhaul (IAB) donor node or an IAB relay node that provides a radio access line and a radio backhaul line by time division multiplexing, frequency division multiplexing, or space division multiplexing.

Note that the radio access technology used by the base station 30 may be a cellular communication technology or a wireless LAN technology. Of course, the radio access technology used by the base station 30 is not limited thereto, and may be another radio access technology. For example, the radio access technology used by the base station 30 may be a low power wide area (LPWA) communication technology. Of course, the wireless communication used by the base station 30 may be wireless communication using a quasi-millimeter wave or a millimeter wave. In addition, the wireless communication used by the base station 30 may be wireless communication using radio waves or wireless communication (optical wireless) using infrared rays or visible light.

The base station 30 may be capable of non-orthogonal multiple access (NOMA) communication with the terminal apparatus 40. Here, the NOMA communication is communication using a non-orthogonal resource (transmission, reception, or both). Note that the base station 30 may be able to perform NOMA communication with another base station 30.

Note that the base stations 30 may be able to communicate with each other via a base station-core network interface (for example, NG Interface, S1 Interface, and the like). This interface may be either wired or wireless. Furthermore, the base stations may be capable of communicating with each other via an inter-base station interface (for example, Xn Interface, X2 Interface, S1 Interface, F1 Interface, and the like). This interface may be either wired or wireless.

Note that the concept of the base station includes not only a donor base station but also a relay base station (relay station). For example, the relay base station may be any one of RF Repeater, Smart Repeater, and Intelligent Surface. In addition, the concept of the base station includes not only a structure having a function of the base station but also an apparatus installed in the structure.

The structure is, for example, a building such as a high-rise building, a house, a steel tower, a station facility, an airport facility, a harbor facility, an office building, a school building, a hospital, a factory, a commercial facility, or a stadium. Note that the concept of a structure includes not only a building but also a construction (non-building structure) such as a tunnel, a bridge, a dam, a wall, or an iron pillar, and equipment such as a crane, a gate, or a windmill. In addition, the concept of the structure includes not only a structure on land (on the ground in a narrow sense) or under the ground, but also a structure on water such as a pier or a mega-float, and a structure under water such as a marine observation facility. The base station may be referred to as an information processing apparatus.

The base station 30 may be a donor station or a relay station. Furthermore, the base station 30 may be a fixed station or a mobile station. The mobile station is a wireless communication apparatus (for example, a base station) configured to be movable. At this time, the base station 30 may be an apparatus installed in a moving body or may be a moving body itself. For example, a relay station having mobility can be regarded as the base station 30 as a mobile station. In addition, an apparatus that is originally an apparatus having mobility and is equipped with a function of a base station (at least a part of the function of the base station), such as a vehicle, an unmanned aerial vehicle (UAV) typified by a drone, or a smartphone, also corresponds to the base station 30 as a mobile station.

Here, the moving body may be a mobile terminal such as a smartphone or a mobile phone. In addition, the moving body may be a moving body (for example, a vehicle such as an automobile, a bicycle, a bus, a truck, a motorcycle, a train, or a linear motor car) that moves on land (on the ground in a narrow sense) or a moving body (for example, the subway) that moves under the ground (for example, in the tunnel).

In addition, the moving body may be a moving body (for example, a ship such as a passenger ship, a cargo ship, or a hovercraft) that moves over water or a moving body (for example, submersible vehicles such as submersibles, submarines, and unmanned submersibles) that moves under water.

Note that the moving body may be a moving body (for example, an aircraft such as an airplane, an airship, or a drone) that moves in the atmosphere.

Furthermore, the base station 30 may be a ground base station (ground station) installed on the ground. For example, the base station 30 may be a base station arranged in a structure on the ground, or may be a base station installed in a moving body moving on the ground. More specifically, the base station 30 may be an antenna installed in a structure such as a building and a signal processing apparatus connected to the antenna. Of course, the base station 30 may be a structure or a moving body itself. The “ground” is a ground in a broad sense including not only on land (on the ground in a narrow sense) but also underground, on water, and underwater. Note that the base station 30 is not limited to a ground base station. For example, in a case where the communication system 1 is a satellite communication system, the base station 30 may be an aircraft station. From the perspective of a satellite station, an aircraft station located on the earth is a ground station.

Note that the base station 30 is not limited to a ground station. The base station 30 may be a non-ground base station (non-ground station) capable of floating in the air or space. For example, the base station 30 may be an aircraft station or a satellite station.

The satellite station is a satellite station capable of floating outside the atmosphere. The satellite station may be an apparatus mounted on a space vehicle such as an artificial satellite, or may be a space vehicle itself. A space vehicle is a moving body that moves outside the atmosphere. Examples of the space vehicle include artificial bodies such as artificial satellites, spacecraft, space stations, and probes.

Note that the satellite serving as the satellite station may be any of a low earth orbiting (LEO) satellite, a medium earth orbiting (MEO) satellite, a geostationary earth orbiting (GEO) satellite, and a highly elliptical orbiting (HEO) satellite. Of course, the satellite station may be an apparatus mounted on a low earth orbiting satellite, a medium earth orbiting satellite, a geostationary earth orbiting satellite, or a highly elliptical orbiting satellite.

An aircraft station is a wireless communication apparatus capable of floating in the atmosphere, such as an aircraft. The aircraft station may be an apparatus mounted on an aircraft or the like, or may be an aircraft itself. Note that the concept of an aircraft includes not only heavy aircraft such as an airplane and a glider but also light aircraft such as a balloon and an airship. In addition, the concept of an aircraft includes not only a heavy aircraft and a light aircraft but also a rotorcraft such as a helicopter and an autogyroscope. Note that the aircraft station (alternatively, an aircraft on which an aircraft station is mounted) may be an unmanned aerial vehicle such as a drone.

Note that the concept of the unmanned aerial vehicle also includes unmanned aircraft systems (UAS) and a tethered UAS. In addition, the concept of unmanned aerial vehicles also includes lighter than air UAS (LTA) and heavier than Air UAS (HTA). Other concepts of unmanned aerial vehicles also include High Altitude UAS Platforms (HAPs).

The size of the coverage of the base station 30 may be large such as a macro cell or small such as a pico cell. Of course, the size of the coverage of the base station 30 may be extremely small such as a femto cell. In addition, the base station 30 may have a beamforming capability. In this case, in the base station 30, a cell or a service area may be formed for each beam.

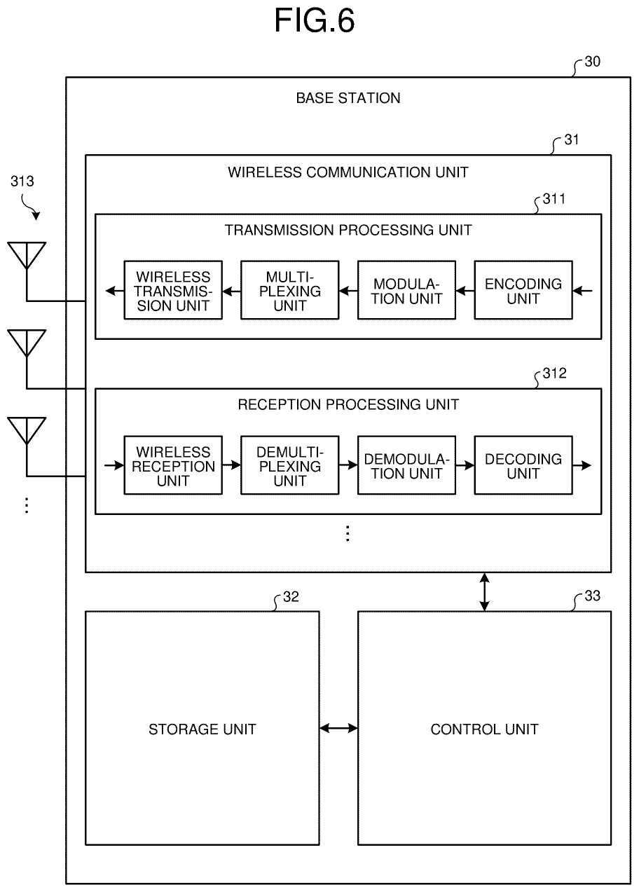

FIG. 6 is a diagram illustrating a configuration example of the base station 30 according to the embodiment of the present disclosure. The base station 30 includes a wireless communication unit 31, a storage unit 32, and a control unit 33. Note that the configuration illustrated in FIG. 6 is a functional configuration, and the hardware configuration may be different from the functional configuration. Furthermore, the functions of the base station 30 may be implemented in a distributed manner in a plurality of physically separated configurations.

The wireless communication unit 31 is a signal processing unit for wirelessly communicating with other wireless communication apparatuses (for example, the terminal apparatus 40). The wireless communication unit 31 operates under the control of the control unit 33. The wireless communication unit 31 corresponds to one or more radio access schemes. For example, the wireless communication unit 31 supports both NR and LTE. The wireless communication unit 31 may be compatible with W-CDMA or cdma2000 in addition to NR or LTE. Furthermore, the wireless communication unit 31 may support an automatic retransmission technology such as hybrid automatic repeat request (HARQ). The wireless communication unit 31 includes a

transmission processing unit 311, a reception processing unit 312, and an antenna 313. The wireless communication unit 31 may include a plurality of transmission processing units 311, a plurality of reception processing units 312, and a plurality of antennas 313. Note that, in a case where the wireless communication unit 31 supports a plurality of radio access schemes, each unit of the wireless communication unit 31 can be configured individually for each radio access scheme. For example, the transmission processing unit 311 and the reception processing unit 312 may be individually configured by LTE and NR. Furthermore, the antenna 313 may include a plurality of antenna elements (for example, a plurality of patch antennas). In this case, the wireless communication unit 31 may be configured to be beamformable. The wireless communication unit 31 may be configured to be able to perform polarization beamforming using vertically polarized waves (V-polarized waves) and horizontally polarized waves (H-polarized waves).

The transmission processing unit 311 performs a process of transmitting the downlink control information and the downlink data. For example, the transmission processing unit 311 encodes the downlink control information and the downlink data input from the control unit 33 using an encoding scheme such as block encoding, convolutional encoding, turbo encoding, or the like. Here, the encoding may be performed by polar code encoding or low density parity check code (LDPC code) encoding. Then, the transmission processing unit 311 modulates the encoded bits by a predetermined modulation scheme such as BPSK, QPSK, 16QAM, 64QAM, or 256QAM. In this case, the signal points on the constellation do not necessarily have to be equidistant. The constellation may be a non uniform constellation (NUC). Then, the transmission processing unit 311 multiplexes the modulation symbol of each channel and the downlink reference signal and arranges the multiplexed symbols in a predetermined resource element. Then, the transmission processing unit 311 performs various types of signal processing on the multiplexed signal. For example, the transmission processing unit 311 performs processing such as conversion into a frequency domain by fast Fourier transform, addition of a guard interval (cyclic prefix), generation of a baseband digital signal, conversion into an analog signal, quadrature modulation, up-conversion, removal of an extra frequency component, and amplification of power. The signal generated by the transmission processing unit 311 is transmitted from the antenna 313.

The reception processing unit 312 processes the uplink signal received via the antenna 313. For example, the reception processing unit 312 performs down-conversion, removal of an unnecessary frequency component, control of an amplification level, quadrature demodulation, conversion to a digital signal, removal of a guard interval (cyclic prefix), extraction of a frequency domain signal by fast Fourier transform, and the like on the uplink signal. Then, the reception processing unit 312 separates an uplink channel such as a physical uplink shared channel (PUSCH) and a physical uplink control channel (PUCCH) and an uplink reference signal from the signals subjected to these processes. Further, the reception processing unit 312 demodulates the reception signal using a modulation scheme such as binary phase shift keying (BPSK) or quadrature phase shift keying (QPSK) with respect to the modulation symbol of the uplink channel. The modulation scheme used for demodulation may be 16 quadrature amplitude modulation (QAM), 64QAM, or 256QAM. In this case, the signal points on the constellation do not necessarily have to be equidistant. The constellation may be a non uniform constellation (NUC). Then, the reception processing unit 312 performs decoding processing on the demodulated encoded bits of the uplink channel. The decoded uplink data and uplink control information are output to the control unit 33.

The antenna 313 is an antenna apparatus (antenna unit) that mutually converts a current and a radio wave. The antenna 313 may include one antenna element (for example, one patch antenna) or may include a plurality of antenna elements (for example, a plurality of patch antennas). In a case where the antenna 313 includes a plurality of antenna elements, the wireless communication unit 31 may be configured to be beamformable. For example, the wireless communication unit 31 may be configured to generate a directional beam by controlling the directivity of a wireless signal using a plurality of antenna elements. Note that the antenna 313 may be a dual-polarized antenna. In a case where the antenna 313 is a dual-polarized antenna, the wireless communication unit 31 may use vertically polarized waves (V-polarized waves) and horizontally polarized waves (H-polarized waves) in transmitting wireless signals. Then, the wireless communication unit 31 may control the directivity of the wireless signal transmitted using the vertically polarized wave and the horizontally polarized wave. Furthermore, the wireless communication unit 31 may transmit and receive spatially multiplexed signals via a plurality of layers including a plurality of antenna elements.

The storage unit 32 is a storage apparatus capable of reading and writing data, such as a DRAM, an SRAM, a flash memory, or a hard disk. The storage unit 32 functions as a storage means of the base station 30.

The control unit 33 is a controller that controls each unit of the base station 30. The control unit 33 is realized by, for example, a processor such as a central processing unit (CPU) or a micro processing unit (MPU). For example, the control unit 33 is implemented by a processor executing various programs stored in a storage apparatus inside the base station 30 using a random access memory (RAM) or the like as a work area. Note that the control unit 33 may be realized by an integrated circuit such as an application specific integrated circuit (ASIC) or a field programmable gate array (FPGA). Any of the CPU, the MPU, the ASIC, and the FPGA can be regarded as a controller. Furthermore, the control unit 33 may be realized by a graphics processing unit (GPU) in addition to or instead of the CPU.

In some embodiments, the concept of a base station may include a collection of a plurality of physical or logical apparatuses. For example, in the present embodiment, the base station may be distinguished into a plurality of apparatuses such as a baseband unit (BBU) and a radio unit (RU). Then, the base station may be interpreted as an assembly of the plurality of apparatuses. In addition, the base station may be either or both of a BBU and an RU. The BBU and the RU may be connected by a predetermined interface (for example, enhanced common public radio interface (eCPRI)). Note that the RU may be referred to as a remote radio unit (RRU) or a radio dot (RD). Furthermore, the RU may correspond to a gNB distributed unit (gNB-DU) described later. Further, the BBU may correspond to a gNB Central Unit (gNB-CU) described below. Alternatively, the RU may be a wireless apparatus connected to a gNB-DU described later. The gNB-CU, the gNB-DU, and the RU connected to the gNB-DU may be configured to conform to an open radio access network (O-RAN). Further, the RU may be an apparatus integrally formed with the antenna. An antenna (for example, an antenna integrally formed with an RU) included in the base station may adopt an Advanced Antenna System and support MIMO (for example, Full Dimension (FD)-MIMO) or beamforming. Furthermore, the antenna included in the base station may include, for example, 64 transmission antenna ports and 64 reception antenna ports.

In addition, the antenna mounted on the RU may be an antenna panel including one or more antenna elements, and the RU may be mounted with one or more antenna panels. For example, the RU may be mounted with two types of antenna panels of a horizontally polarized antenna panel and a vertically polarized antenna panel, or two types of antenna panels of a clockwise circularly polarized antenna panel and a counterclockwise circularly polarized antenna panel. In addition, the RU may form and control an independent beam for each antenna panel. Note that a plurality of base stations may be

connected to each other. The one or more base stations may be included in a radio access network (RAN). In this case, the base station may be simply referred to as a RAN, a RAN node, an access network (AN), or an AN node. Note that the RAN in LTE is sometimes referred to as an enhanced universal terrestrial RAN (EUTRAN). In addition, RAN in NR may be referred to as NGRAN. In addition, RAN in W-CDMA (UMTS) is sometimes referred to as UTRAN.

Note that an LTE base station may be referred to as an evolved node B (eNodeB) or an eNB. At this time, the EUTRAN includes one or more eNodeBs (eNBs). Further, an NR base station may be referred to as a gNodeB or a gNB. At this time, the NGRAN includes one or more gNBs. The EUTRAN may include a gNB (en-gNB) connected to a core network (EPC) in an LTE communication system (EPS). Similarly, the NGRAN may include an ng-eNB connected to a core network 5GC in a 5G communications system (5GS).

Note that, in a case where the base station is an eNB, a gNB, or the like, the base station may be referred to as 3GPP access. In addition, in a case where the base station is a wireless access point, the base station may be referred to as non-3GPP access. Further, the base station may be an optical extension apparatus called a remote radio head (RRH) or a radio unit (RU). Furthermore, in a case where the base station is a gNB, the base station may be a combination of the gNB-CU and the qNB-DU described above, or may be any one of the gNB-CU and the gNB-DU.

Here, the gNB-CU hosts a plurality of upper layers (for example, radio resource control (RRC), service data adaptation protocol (SDAP), and packet data convergence protocol (PDCP)) in an access stratum for communication with the UE. Meanwhile, the gNB-DU hosts a plurality of lower layers (for example, radio link control (RLC), medium access control (MAC), and physical layer (PHY)) in an access stratum. That is, among messages/information to be described later, RRC signaling (semi-static notification) may be generated by the gNB-CU, while MAC CE and DCI (dynamic notification) may be generated by the gNB-DU. Alternatively, in the RRC configuration (semi-static notification), for example, some configurations such as IE:cellGroupConfig may be generated by the gNB-DU, and the remaining configurations may be generated by the gNB-CU. These configurations may be transmitted and received through an F1 interface described later.

Note that the base station may be configured to be able to communicate with another base station. For example, in a case where a plurality of base stations is eNBs or a combination of an eNB and an en-gNB, the base stations may be connected by an X2 interface. Furthermore, in a case where a plurality of base stations is gNBs or a combination of a gn-eNB and a gNB, the apparatuses may be connected by an Xn interface. Furthermore, in a case where a plurality of base stations is a combination of a gNB-CU and a gNB-DU, the apparatuses may be connected by the above-described F1 interface. A message/information (for example, RRC signaling, MAC control element (MAC CE), or DCI) to be described later may be transmitted between a plurality of base stations, for example, via an X2 interface, an Xn interface, or an F1 interface.

A cell provided by the base station may be referred to as a serving cell. The concept of the serving cell includes a primary cell (PCell) and a secondary cell (SCell). In a case where dual connectivity is configured for a UE (for example, the terminal apparatus 40), the PCell provided by the master node (MN) and zero or one or more SCells may be referred to as a master cell group. Examples of dual connectivity include EUTRA-EUTRA Dual Connectivity, EUTRA-NR Dual Connectivity (ENDC), EUTRA-NR Dual Connectivity with 5GC, NR-EUTRA Dual Connectivity (NEDC), and NR-NR Dual Connectivity.

Note that the serving cell may include a PSCell (Primary Secondary Cell or Primary SCG Cell). In a case where dual connectivity is configured for the UE, the PSCell provided by the secondary node (SN) and zero or one or more SCells may be referred to as secondary cell group (SCG). Unless specially configured (for example, PUCCH on SCell), the physical uplink control channel (PUCCH) is transmitted in the PCell and the PSCell, but is not transmitted in the SCell. In addition, a radio link failure is also detected in the PCell and the PSCell, but is not detected in the SCell (may not be detected). As described above, since the PCell and the PSCell have a special role in the serving cell, they are also referred to as special cell (SpCell).

One downlink component carrier and one uplink component carrier may be associated with one cell. In addition, the system bandwidth corresponding to one cell may be divided into a plurality of bandwidth parts (BWPs). In this case, one or more BWPs may be configured for the UE, and one BWP may be used for the UE as an active BWP. Furthermore, radio resources (for example, a frequency band, a numerology (subcarrier spacing), and a slot format (slot configuration) that can be used by the terminal apparatus 40 may be different for each cell, each component carrier, or each BWP.

### <2-4. Configuration of Terminal Apparatus>

Next, a configuration of the terminal apparatus 40 will be described.

The terminal apparatus 40 is a wireless communication apparatus that wirelessly communicates with other communication apparatuses such as the base station 30. The information processing apparatus can perform wireless connection using not only Sub6 (less than 6 GHZ) but also a quasi-millimeter wave band (20 GHZ to 30 GHz band) or a millimeter wave band (30 GHZ to 300 GHz band).

The terminal apparatus 40 is, for example, a mobile terminal such as a mobile phone, a smart device (smartphone or tablet), a personal digital assistant (PDA), or a notebook PC. Furthermore, the terminal apparatus 40 may be a device such as a business camera provided with a communication function, or may be a motorcycle, a moving relay vehicle, or the like on which a communication device such as a field pickup unit (FPU) is mounted. Furthermore, the terminal apparatus 40 may be a machine to machine (M2M) device or an Internet of things (IoT) device. Furthermore, the terminal apparatus 40 may be a wearable device such as a smart watch.

Note that the terminal apparatus 40 may be an xR device such as an augmented reality (AR) device, a virtual reality (VR) device, or a mixed reality (MR) device. At this time, the xR device may be a glasses-type device such as AR glasses or MR glasses, or may be a head-mounted-type device such as a VR head-mounted display. In a case where the terminal apparatus 40 is an xR device, the terminal apparatus 40 may be a standalone device including only a user wearing portion (for example, the eyeglass portion). Furthermore, the terminal apparatus 40 may be a terminal interlocking device including a user wearing portion (for example, the eyeglass portion) and a terminal portion (for example, a smart device) interlocked with the portion.

Note that the terminal apparatus 40 may be able to perform NOMA communication with the base station 30. Furthermore, the terminal apparatus 40 may be able to use an automatic retransmission technology such as HARQ when communicating with the base station 30. Furthermore, the terminal apparatus 40 may be capable of sidelink communication with another terminal apparatus 40. The terminal apparatus 40 may also be able to use an automatic retransmission technology such as HARQ when performing sidelink communication. Note that the terminal apparatus 40 may also be capable of NOMA communication in communication (sidelink) with other terminal apparatuses 40. Furthermore, the terminal apparatus 40 may be able to perform LPWA communication with another communication apparatus (for example, the base station 30 and another terminal apparatus 40). Furthermore, the wireless communication used by the terminal apparatus 40 may be wireless communication using millimeter waves. Note that the wireless communication (including sidelink communication) used by the terminal apparatus 40 may be wireless communication using radio waves or wireless communication (optical wireless) using infrared rays or visible light.

Furthermore, the terminal apparatus 40 may be a mobile apparatus. The mobile apparatus is a mobile wireless communication apparatus. At this time, the terminal apparatus 40 may be a wireless communication apparatus installed in a moving body or may be a moving body itself. For example, the terminal apparatus 40 may be a vehicle that moves on a road such as an automobile, a bus, a truck, or a motorcycle, a vehicle that moves on a rail installed on a track such as a train, or a wireless communication apparatus mounted on the vehicle. Note that the moving body may be a mobile terminal, or may be a moving body that moves on land (on the ground in a narrow sense), under the ground, on water, or under water. Furthermore, the moving body may be a moving body that moves inside the atmosphere, such as a drone or a helicopter, or may be a moving body that moves outside the atmosphere, such as an artificial satellite.

The terminal apparatus 40 may be simultaneously connected to a plurality of base stations or a plurality of cells to perform communication. For example, in a case where one base station supports a communication area via a plurality of cells (for example, pCell and sCell), the plurality of cells can be bundled and communicated between the base station 30 and the terminal apparatus 40 by a carrier aggregation (CA) technology, a dual connectivity (DC) technology, or a multi-connectivity (MC) technology. Alternatively, the terminal apparatus 40 and the plurality of base stations 30 can communicate with each other by a coordinated transmission and reception (COMP: Coordinated Multi-Point Transmission and Reception) technology via cells of different base stations 30.

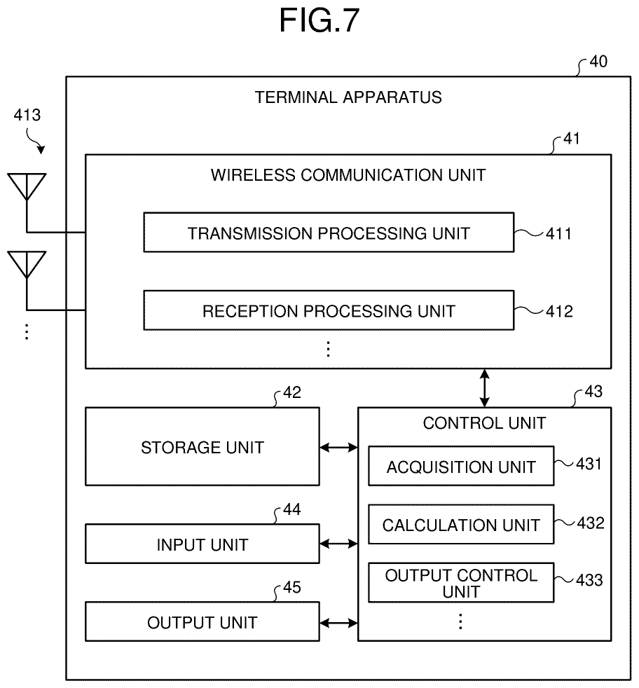

FIG. 7 is a diagram illustrating a configuration example of the terminal apparatus 40 according to the embodiment of the present disclosure. The terminal apparatus 40 includes a wireless communication unit 41, a storage unit 42, a control unit 43, an input unit 44, and an output unit 45. Note that the configuration illustrated in FIG. 7 is a functional configuration, and the hardware configuration may be different from the functional configuration. Furthermore, the functions of the terminal apparatus 40 may be implemented in a distributed manner in a plurality of physically separated configurations.

The wireless communication unit 41 is a signal processing unit for wirelessly communicating with other wireless communication apparatuses (for example, the base station 30 and another terminal apparatus 40). The wireless communication unit 41 operates under the control of the control unit 43. The wireless communication unit 41 includes a transmission processing unit 411, a reception processing unit 412, and an antenna 413. The configurations of the wireless communication unit 41, the transmission processing unit 411, the reception processing unit 412, and the antenna 413 may be similar to those of the wireless communication unit 31, the transmission processing unit 311, the reception processing unit 312, and the antenna 313 of the base station 30. Further, the wireless communication unit 41 may be configured to be beamformable similarly to the wireless communication unit 31. Further, similarly to the wireless communication unit 31, the wireless communication unit 41 may be configured to be able to transmit and receive spatially multiplexed signals.

The storage unit 42 is a storage apparatus capable of reading and writing data, such as a DRAM, an SRAM, a flash memory, or a hard disk. The storage unit 42 functions as a storage means of the terminal apparatus 40.

The control unit 43 is a controller that controls each unit of the terminal apparatus 40. The control unit 43 is realized by, for example, a processor such as a CPU or an MPU. For example, the control unit 43 is realized by a processor executing various programs stored in a storage apparatus inside the terminal apparatus 40 using a RAM or the like as a work area. Note that the control unit 43 may be realized by an integrated circuit such as an ASIC or an FPGA. Any of the CPU, the MPU, the ASIC, and the FPGA can be regarded as a controller. Furthermore, the control unit 43 may be realized by a GPU in addition to or instead of the CPU.

As illustrated in FIG. 7, the control unit 43 includes an acquisition unit 431, a calculation unit 432, and an output control unit 433. Each block (the acquisition unit 431 to the output control unit 433) constituting the control unit 43 is a functional block indicating a function of the control unit 43. These functional blocks may be software blocks or hardware blocks. For example, each of the functional blocks described above may be one software module realized by software (including microprograms), or may be one circuit block on a semiconductor chip (die). Of course, each functional block may be one processor or one integrated circuit. The control unit 43 may be configured by a functional unit different from the above-described functional block. A configuration method of the functional block is arbitrary. The operation of the control unit 43 may be the same as the operation of each block of the control unit 13 of the server 10.

The input unit 44 is an input apparatus that receives various inputs from the outside. For example, the input unit 44 is an operation apparatus for the user to perform various operations, such as a keyboard, a mouse, and operation keys. Note that, in a case where a touch panel is adopted as the terminal apparatus 40, the touch panel is also included in the input unit 44. In this case, the user performs various operations by touching the screen with a finger or a stylus.

The output unit 45 is an apparatus that performs various outputs such as sound, light, vibration, and an image to the outside. The output unit 45 performs various outputs to the user under the control of the control unit 43. Note that the output unit 45 includes a display apparatus that displays various types of information. The display apparatus is, for example, a liquid crystal display or an organic electro luminescence (EL) display. Note that the output unit 45 may be a touch panel type display apparatus. In this case, the input unit 44 and the output unit 45 may be regarded as an integrated configuration. The output unit 45 may be an output unit of an xR device such as AR glasses.

### 3. OPERATION OF COMMUNICATION SYSTEM

The configuration of the communication system 1 has been described above. Next, the operation of the communication system 1 having such a configuration will be described. The operation of the communication system 1 is divided into information collection processing and heat map providing processing.

Note that, in the following description, it is assumed that the server 101 is an information collection server and the server 102 is a heat map providing server, but the information collection server and the heat map providing server may be one server 10.

### <3-1. Information Collection Processing>

First, information collection processing will be described. The information collection processing is processing for the server 10 to collect information regarding wireless connection from the plurality of terminal apparatuses 40. The information regarding the wireless connection includes time information, position information, radio field intensity, and information regarding a terminal direction when each of the plurality of terminal apparatuses 40 performs wireless connection using a predetermined frequency band (for example, the frequency bands included in the quasi-millimeter wave band and the millimeter wave band). The terminal direction is a direction in which the terminal apparatus 40 faces. For example, the terminal direction is a front direction of the user holding the terminal apparatus 40. The terminal apparatus 40 may set the traveling direction of the terminal apparatus 40 determined on the basis of information from a sensor such as a global positioning system (GPS) sensor or an acceleration sensor as the terminal direction.

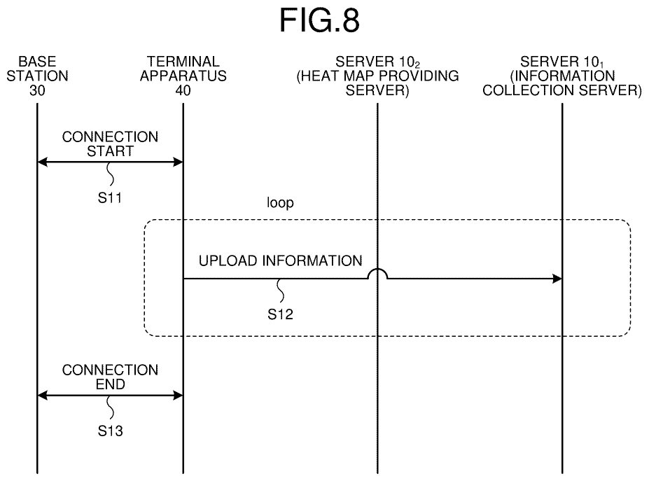

FIG. 8 is a sequence diagram illustrating an example of information collection processing. Hereinafter, information collection processing will be described with reference to the sequence diagram of FIG. 8.

When entering the quasi-millimeter wave or millimeter wave support area, the terminal apparatus 40 starts wireless connection to the base station 30 (step S11).

Then, the terminal apparatus 40 detects information regarding wireless connection (for example, reception time information of a quasi-millimeter wave or a millimeter wave, reception position information, radio field intensity information, and information in a terminal direction at the time of reception) and transmits the information to the server 10 (step S12). The terminal apparatus 40 repeats detection and transmission of information regarding wireless connection until the wireless connection using the quasi-millimeter wave or the millimeter wave is terminated. The server 101 acquires information regarding wireless connection from each of the plurality of terminal apparatuses 40.

When leaving the quasi-millimeter wave or millimeter wave support area, the terminal apparatus 40 disconnects the wireless connection with the base station 30 (step S13).

### <3-2. Heat Map Providing Processing>

Next, heat map providing processing will be described. The heat map providing processing is processing for providing the heat map to the terminal apparatus 40. The heat map is a map in which a display indicating the intensity of the radio wave of the quasi-millimeter wave or the millimeter wave and the terminal direction optimal for the reception thereof is superimposed and displayed on the map for each point on the map.

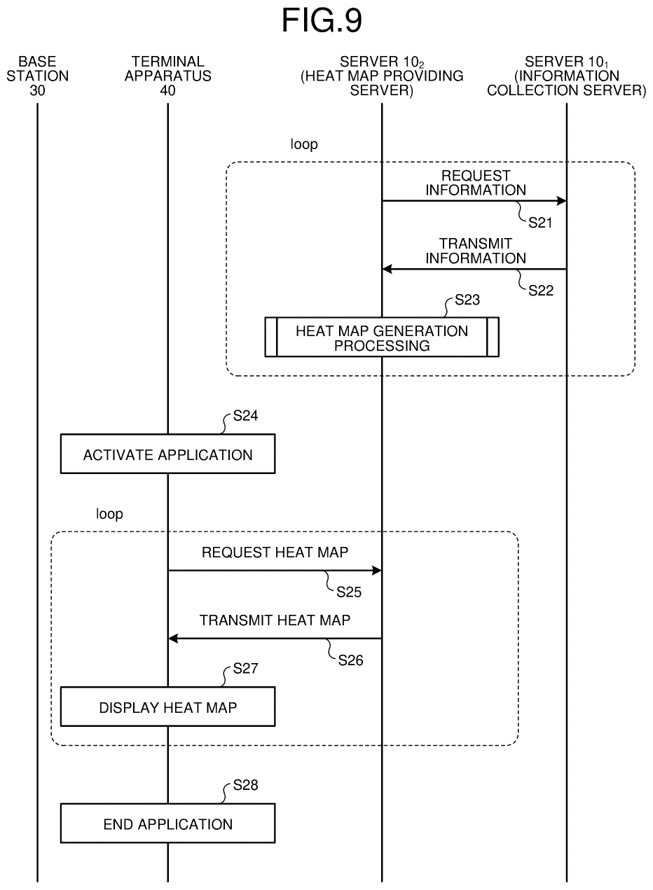

FIG. 9 is a sequence diagram illustrating an example of heat map providing processing. Hereinafter, the heat map providing processing will be described with reference to the sequence diagram of FIG. 9.

The server 102 requests the server 101 to transmit the collected information (step S21). The acquisition information is information regarding wireless connection transmitted from each of the plurality of terminal apparatuses 40. In the following description, the collected information may be referred to as collected data. The server 101 transmits the collected data to the server 102 (step S22). The server 102 executes heat map generation processing of generating a heat map on the basis of the collected data (step S23). The heat map generation processing will be described in detail later. The server 10 repeats the processing of steps S21 to S23 at regular time intervals (for example, a 24-hour interval).

When the user performs an operation of activating an application for displaying the heat map (hereinafter, simply referred to as an application), the application is activated (step S24).

When the user performs a predetermined operation on the application, the terminal apparatus 40 requests the server 102 to transmit the heat map of the geographical position designated by the user (step S25). The geographical position may be a point (for example, one point on the map specified by coordinates) or an area (for example, a range on a map designated by an administrative district). In the present embodiment, the geographical position is an area divided into a lattice shape. When receiving the request, the output control unit 133 of the server 102 transmits the heat map of the designated geographical position to the terminal apparatus 40 (step S26).

The acquisition unit 431 of the terminal apparatus 40 acquires the heat map from the server 102. Then, the output control unit 433 of the terminal apparatus 40 displays the heat map transmitted from the server 102 on the output unit 45 (step S27). Note that, in the processing of step S27, it can be regarded that the output control unit 133 of the server 102 has controlled the output of the output unit 45 of the terminal apparatus 40 via the network and the control unit 13 of the terminal apparatus 40.

The terminal apparatus 40 and the server 102 repeat the processing of steps S24 to S27 until the application is terminated.

When the user performs an operation to end the application, the application is terminated (step S28).

### <3-3. Heat Map Generation Processing>

Next, heat map generation processing will be described. The heat map generation processing is processing for generating a heat map. The heat map generation processing may be executed at regular time intervals, or may be executed on the basis of a request from the terminal apparatus 40. In the following description, it is assumed that information of a geographical position to be a generation target of the heat map is designated by the terminal apparatus 40 or by a predetermined program in the server 102.

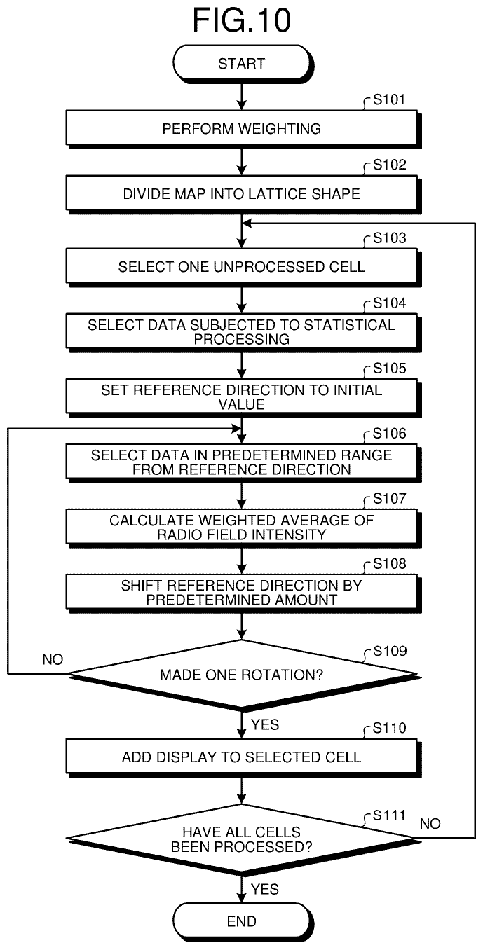

FIG. 10 is a flowchart illustrating an example of heat map generation processing. The heat map generation processing is executed by the control unit 13 (for example, the calculation unit 432) of the server 102, for example. Hereinafter, the heat map generation processing will be described with reference to the flowchart of FIG. 10.

The server 102 performs weighting on the collected information regarding the wireless connection in order to reduce the influence of the old information. The server 102 performs weighting on the basis of the time information included in the collected information regarding the wireless connection (step S101). The weighting is performed, for example, as follows.

For example, when performing weighting to eliminate the influence of old information, the server 102 acquires information of a preset number of valid days, and sets the weight w of information effectively acquired before the number of valid days to 0.0. At this time, assuming that the number of elapsed days from acquisition of the weighting target data (information regarding wireless connection) is D_{S} and the number of valid days of data is D_{V}, the weight w of each data can be calculated on the basis of the following Formulas (1) and (2).

$$W = 1. \times ( {D}_{V} - {D}_{S} ) / {D}_{V} ( {D}_{V} \geq {D}_{s} ) \qquad ( 1 )$$

$$W = 0 ( {D}_{V} < {D}_{s} ) \qquad ( 2 )$$

Here, Formula (1) is a formula in the case of D_{V}≥D_{S}, and Formula (2) is a formula in the case of D_{V}<D_{S}.

Subsequently, the server 10₂ divides an area (hereinafter, referred to as a heat map creation area) on the map set on the basis the geographical position into a plurality of areas. In the present embodiment, the server 10₂ divides the heat map creation area into a lattice shape (step S102). In the following description, each of a plurality of areas divided into a lattice shape may be referred to as a cell. Note that this cell is different from the cell (for example, NR cell) formed by the base station 30. In addition, the display indicating each of the plurality of cells on the map may be referred to as area display or simply cell.

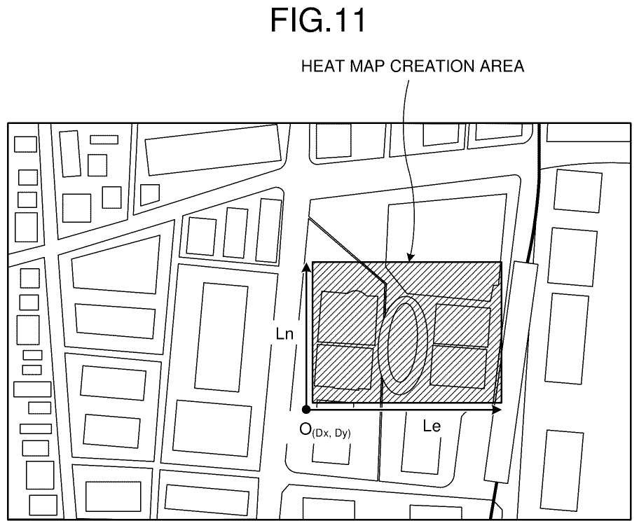

FIG. 11 is a diagram for explaining division processing of the heat map creation area. One cell is constituted by, for example, a square having a side length L in a range of 1 m to 100 m. The heat map creation area is determined by, for example, an origin O_{(Dx, Dy)} when latitude is indicated as Dx and longitude is indicated as Dy, a length In in a north direction from the origin O, and a length Le in an east direction from the origin O. At this time, each of In and Le is a value larger than 0. The server 10₂ divides the heat map creation area into a plurality of cells by drawing lines orthogonal to each other with L widths in the north and east directions with reference to the origin O. The number of cells N_{R} in the row direction and the number of cells N_{C} in the column direction at this time are expressed by the following Formulas (3) and (4).

$${N}_{R} = ceil ( Le / L ) \qquad ( 3 )$$

$${N}_{C} = ceil ( Ln / L ) \qquad ( 4 )$$

Here, ceil represents a ceiling function.

Subsequently, the server 10₂ performs statistical processing on each of the plurality of cells to calculate radio field intensity and direction information for each of the plurality of cells. The server 10₂ adds a display indicating radio field intensity and direction information to each cell.

Note that the direction information is a direction in which the wireless connection is facilitated in a case where the wireless connection using a high frequency band such as a millimeter wave is performed. More specifically, the direction information is information indicating a direction in which the radio field intensity increases in a case where the terminal apparatus 40 performs wireless connection using a predetermined frequency band (for example, the frequency bands included in the quasi-millimeter wave band and the millimeter wave band) in the corresponding cell. The direction information is calculated on the basis of the information regarding the wireless connection collected from the plurality of terminal apparatuses 40 in the cell. As described above, the information regarding the wireless connection includes at least information regarding the radio field intensity and the terminal direction when each of the plurality of terminal apparatuses 40 performs the wireless connection using the predetermined frequency band.

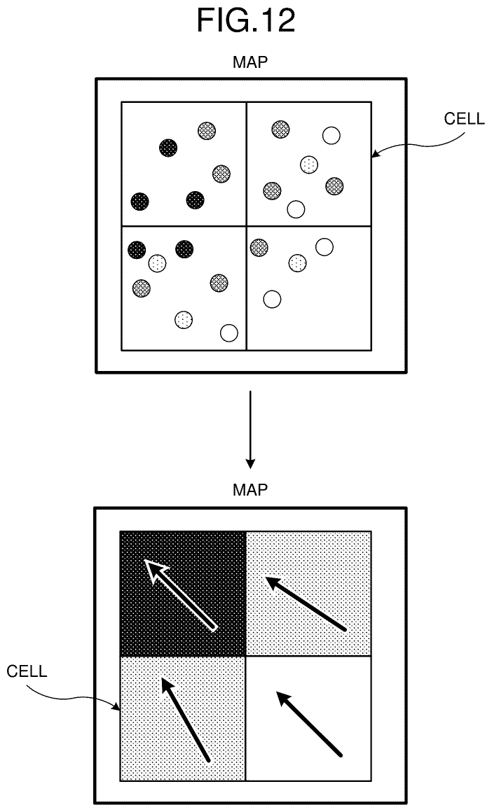

FIG. 12 is a diagram illustrating a state in which a display indicating radio field intensity and direction information is added to each cell. Each square in the map is an area display indicating a cell. Each point in the upper map indicates a data collection position. The darker hatched points indicate that the radio field intensity is higher. The server 10₂ calculates the radio field intensity and the direction information for each cell by performing statistical processing on the collected data existing in each cell. A display indicating radio field intensity and direction information is added to each cell in the lower map. A cell with a darker hatch indicates that the radio field intensity is higher. An arrow in the cell indicates direction information. Note that the example illustrated in FIG. 12 is merely an example. The display indicating the radio field intensity and the direction information is not limited to the example illustrated in FIG. 12.

Step S103 to step S111 in FIG. 10 are specific examples of the above processing. The above processing will be specifically described with reference to the flowchart of FIG. 10.

First, the server 10₂ selects one unprocessed cell from among a plurality of cells (step S103). Then, the server 10₂ selects data to be processed from the collected data (step S104). For example, the server 10₂ sets collected data (information regarding wireless connection) whose position information included in the information regarding wireless connection indicates the inside of the corresponding cell as processing target data.

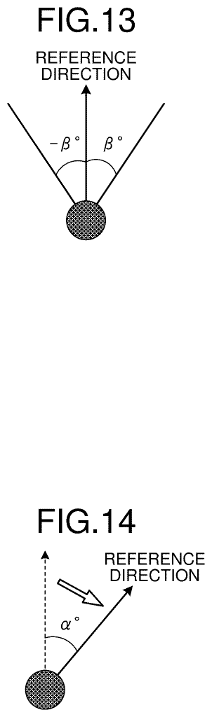

Then, the server 10₂ calculates the direction information on the basis of the processing target data. As described above, the direction information is information indicating a direction in which the radio field intensity increases in a case where the terminal apparatus 40 performs the wireless connection using the predetermined frequency band in the corresponding cell. FIGS. 13 to 15 are diagrams for explaining calculation processing of direction information. Hereinafter, calculation processing of direction information will be described with reference to FIGS. 13 to 15.

First, the server 10₂ sets the reference direction to an initial value (step S105). The reference direction is a parameter used when the radio field intensity for each angle is calculated. For example, the server 10 sets the initial value to 0°. 0° is, for example, the north direction.

The server 10₂ calculates the direction information by repeatedly executing the processing of calculating the radio field intensity in the reference direction while shifting the reference direction. Specifically, the server 10₂ calculates the weighted average of the radio field intensity in each reference direction by repeating the processing of steps S106 to S108 in FIG. 10, and calculates the direction information by obtaining the direction in which the value is maximized.

Here, assuming that the angle at which the reference direction is shifted is α° and the angle at which the search is performed based on the reference direction is β°, these values are, for example, as in the following Formulas (5) and (6).

$$0 < α < 2 β \qquad ( 5 )$$

$$0 < β < 180 \qquad ( 6 )$$

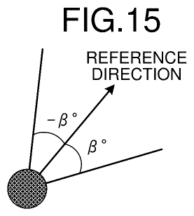

Hereinafter, the processing of steps S106 to S108 will be specifically described. First, the server 10₂ selects collected data from among processing target data, the collected data having a terminal direction falling within a predetermined range (range of −β° to β° illustrated in FIG. 13) from the reference direction (step S106). Then, the server 10₂ calculates a weighted average of the radio field intensity on the basis of the selected data (step S107). At this time, the server 10₂ calculates a weighted average using the weight calculated in step S101. Then, the server 10₂ shifts the reference direction by a predetermined amount (step S108). For example, as illustrated in FIG. 14, the server 10₂ rotates the reference direction clockwise by α°. Then, the server 10₂ again calculates the weighted average of the radio field intensity on the basis of the collected data having the terminal direction falling within the predetermined range (range of −β° to β° illustrated in FIG. 15) from the reference direction.

Subsequently, the server 10₂ determines whether the reference direction has made one rotation (step S109). In a case where one rotation has not been made (step S109: No), the server 10₂ returns the processing to step S106. In the case of one rotation (step S109: Yes), the server 10₂ adds a display indicating the maximum value of the calculated weighted average of the radio field intensity and the information (that is, the direction information) in the reference direction when the value is calculated to the area display of the processing target cell (step S110).

Subsequently, the server 10₂ determines whether all the cells have been processed (step S111). In a case where not all the cells have been processed (step S111: No), the server 10₂ returns the processing to step S103. In a case where all the cells have been processed (step S111: Yes), the server 10₂ ends the heat map generation processing.

### 4. MODIFICATIONS

The above-described embodiments are examples, and various modifications and applications are possible.

### 4-1. First Modification Related to Output Control

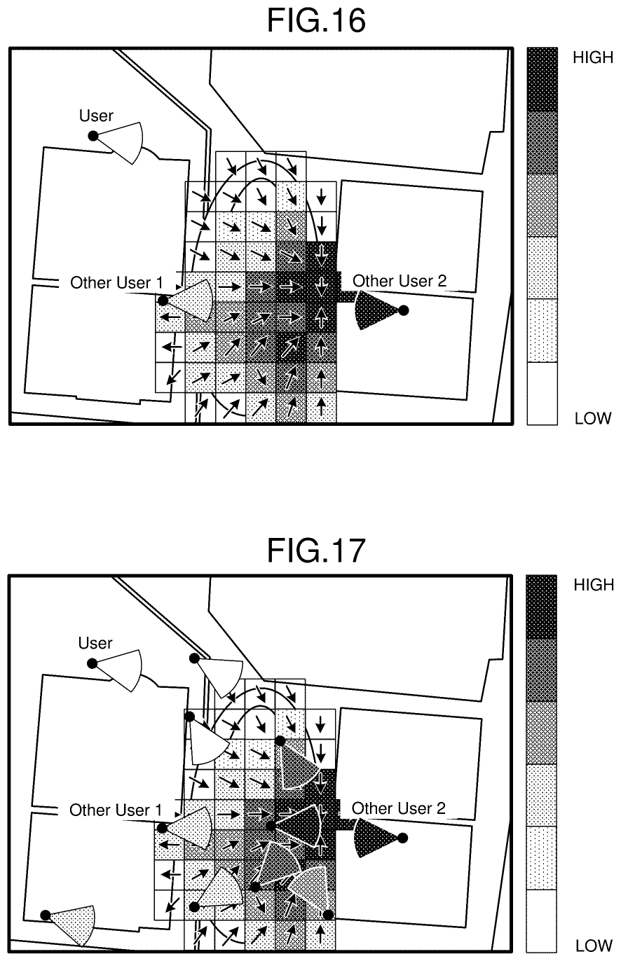

In the above-described embodiment, the heat map as illustrated in FIG. 1 is illustrated as an output example of the heat map. However, the terminal apparatus 40 may display information indicating its own position, terminal direction, and radio field intensity on the heat map. FIG. 16 is a diagram illustrating an example of a heat map according to a first modification. In the example of FIG. 16, the terminal apparatus 40 superimposes and displays a display (display indicated by “User” in the drawing) indicating its own position, terminal direction, and radio field intensity on the heat map.

Note that the terminal apparatus 40 may display, in addition to its own information, information indicating a terminal direction and radio field intensity of another terminal apparatus 40 that currently performs wireless connection using a predetermined frequency band (for example, the frequency bands included in the quasi-millimeter wave band and the millimeter wave band) on the heat map. In the example of FIG. 16, in addition to its own information, the terminal apparatus 40 superimposes and displays a display (display indicated by “Other User 1” and “Other User 2” in the drawing) indicating the positions, the terminal directions, and the radio field intensities of other terminal apparatuses 40 that currently perform wireless connection using a predetermined frequency band on the heat map.

Furthermore, the terminal apparatus 40 may display, on the heat map, information indicating the terminal directions and the radio field intensities of other terminal apparatuses 40 that have performed wireless connection using a predetermined frequency band (for example, the frequency bands included in the quasi-millimeter wave band and the millimeter wave band) in the past predetermined period. FIG. 17 is a diagram illustrating another example of the heat map according to the first modification. In the example of FIG. 17, in addition to the information of the terminal apparatus 40 that currently performs the wireless connection using the predetermined frequency band, the terminal apparatus 40 superimposes and displays the display indicating the positions, the terminal directions, and the radio field intensities of other terminal apparatuses 40 that have performed the wireless connection using the predetermined frequency band in the past predetermined period on the heat map.

Note that the heat map (for example, the heat map illustrated in FIGS. 16 and 17) according to the first modification may be generated by the server 10 or may be generated by the terminal apparatus 40. In a case where the server 10 generates the heat map, the server 10 may create the heat map on which the information of the terminal apparatus 40 is displayed in a superimposed manner. Furthermore, the terminal apparatus 40 may superimpose and display information of itself or other terminal apparatuses 40 on the heat map provided from the server 10.

### 4-2. Second Modification Related to Output Control

In the above-described embodiment, the flowchart illustrated in FIG. 10 is illustrated as an example of the heat map generation processing. At this time, the server 10 may calculate the radio field intensity and the direction information for each weather. Then, the server 10 may additionally acquire current weather information from the terminal apparatus 40 of the user, and display indicating the radio field intensity and the direction information calculated for each weather may be superimposed and displayed on the map.

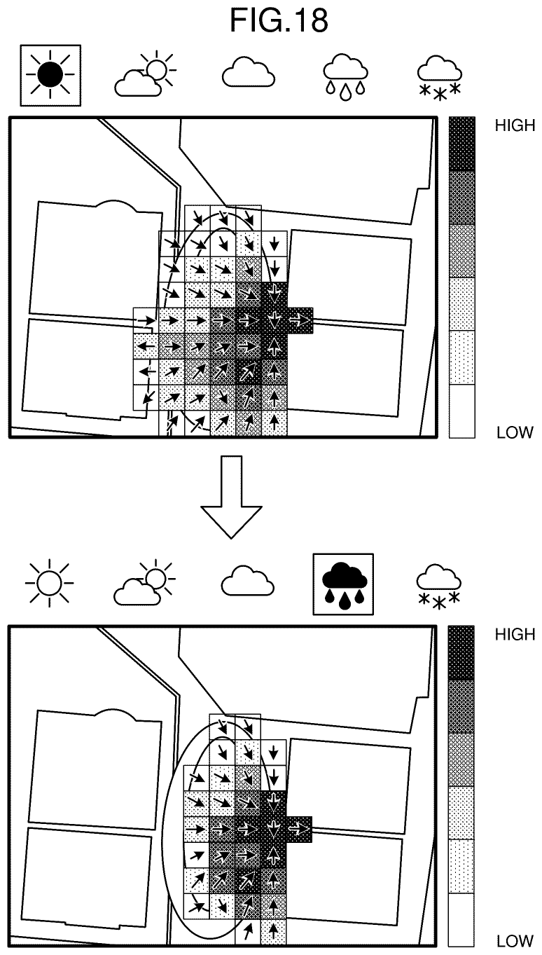

FIG. 18 is a diagram illustrating an example of a heat map according to a second modification. The upper diagram in FIG. 18 is a heat map when it is sunny, and the lower diagram in FIG. 18 is a heat map when it is rainy. In the example of FIG. 18, the server 10 changes the cells displayed in the heat map for each weather, and superimposes and displays a display indicating the radio field intensity and the direction information calculated for each weather on each cell on the heat map.

Note that the heat map (for example, the heat map illustrated in FIG. 18) according to the second modification may be generated by the server 10 or may be generated by the terminal apparatus 40. Furthermore, the terminal apparatus 40 may acquire a plurality of heat maps for each weather from the server 10 and switch the heat map to be displayed on the output unit 45 according to the current weather.

### 4-3. Third Modification Related to Output Control

In the above-described embodiment, the heat map as illustrated in FIG. 1 is illustrated as an output example of the heat map. At this time, the terminal apparatus 40 may hide a cell satisfying a predetermined condition.

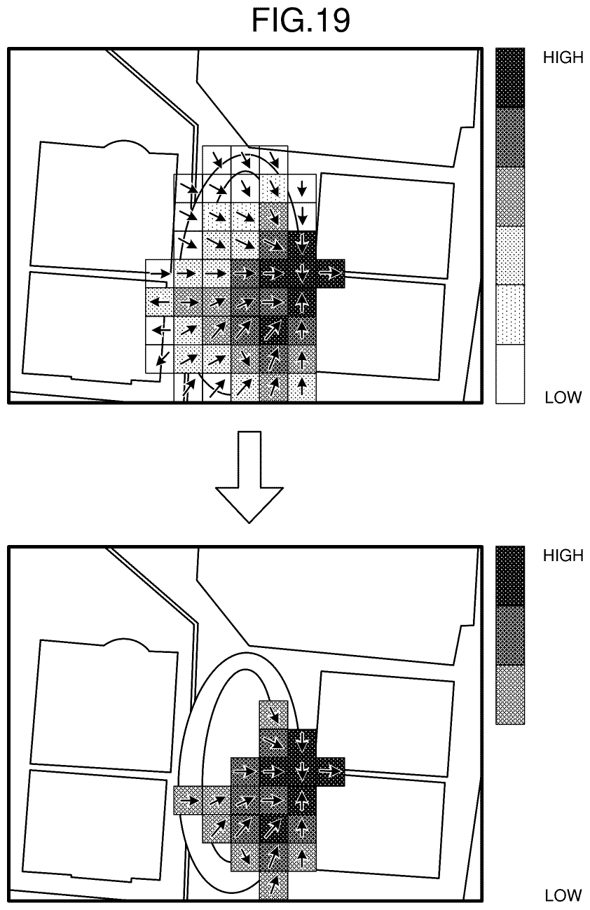

For example, the terminal apparatus 40 may switch the display/non-display of the cell for each radio field intensity on the basis of the operation of the user so that the user can easily grasp the position with high radio field intensity. FIG. 19 is a diagram illustrating an example of a heat map according to a third modification. The upper diagram in FIG. 19 is an example in which cells of all radio field intensities are displayed, and the lower diagram in FIG. 19 is an example in which cells of predetermined radio field intensities (radio field intensities in three levels from the bottom among the six levels of radio field intensities in the example in FIG. 19) are hidden.

Furthermore, the terminal apparatus 40 may hide cells in a predetermined area such as an inaccessible area. The inaccessible area is an area that a user cannot usually enter, such as an inside of a stadium or a private land.

Note that the heat map (for example, the heat map illustrated in FIG. 19) according to the third modification may be generated by the server 10 or may be generated by the terminal apparatus 40. Furthermore, the terminal apparatus 40 may acquire a heat map in which cells of a predetermined area are displayed/hidden from the server 10, and switch the heat map to be displayed on the output unit 45 on the basis of an operation of the user.

### 4-4. Fourth Modification Related to Output Control

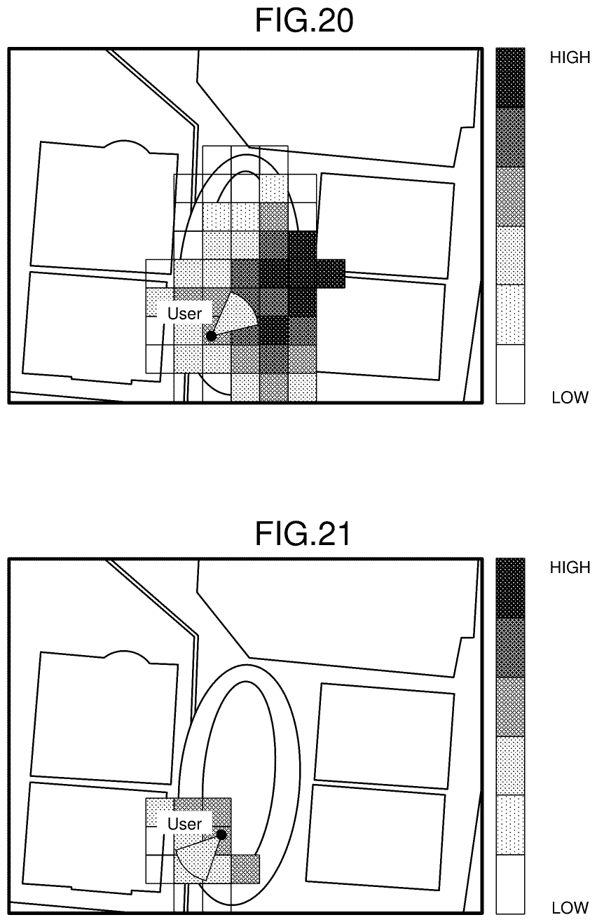

The terminal apparatus 40 may change the intensity display of the heat map depending on the current terminal direction of the terminal apparatus 40. FIGS. 20 and 21 are diagrams illustrating an example of a heat map according to a fourth modification. The terminal apparatus 40 selects a cell to be displayed on the heat map on the basis of the current terminal direction of the terminal apparatus 40. In the example of FIG. 20, the terminal apparatus 40 faces the northeast. Therefore, in the example of FIG. 20, many cells in the northeast direction from the terminal apparatus 40 are selected as the cells to be displayed on the heat map. Meanwhile, in the example of FIG. 21, the terminal apparatus 40 faces the southwest. Therefore, in the example of FIG. 21, many cells in the southwest direction from the terminal apparatus 40 are selected as the cells to be displayed on the heat map. Note that, in a case where such display is performed, the terminal apparatus 40 may not add the display indicating the direction information to each cell.

Note that the heat map (for example, the heat map illustrated in FIGS. 20 and 21) in which the intensity display is changed may be generated by the server 10 or may be generated by the terminal apparatus 40. Furthermore, the terminal apparatus 40 may acquire a heat map on which a plurality of cells is superimposed from the server 10, and erase the cells on the heat map on the basis of the current terminal direction of the terminal apparatus 40.

### 4-5. Fifth Modification Related to Output Control

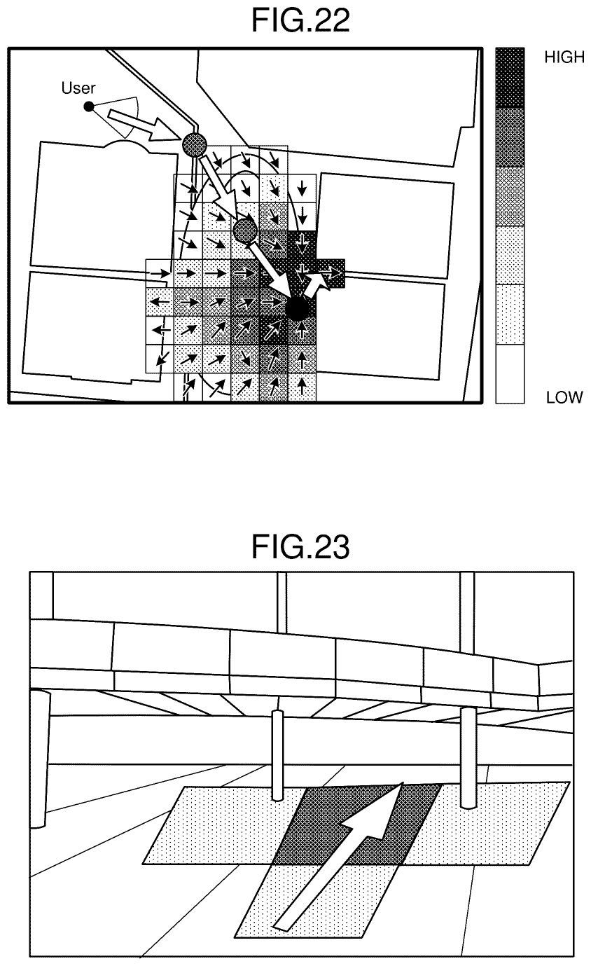

The terminal apparatus 40 may perform route display on the heat map for the purpose of guiding the user toward a place with high radio field intensity. FIG. 22 is a diagram illustrating an example of a heat map according to a fifth modification. In the example of FIG. 22, the terminal apparatus 40 displays the route display generated on the basis of the information of the radio field intensity of each of the plurality of cells on the heat map. An outlined arrow and a circle ahead of the arrow in the drawing are route display.

The terminal apparatus 40 may perform route display on the xR space (for example, the AR space). FIG. 23 is a diagram illustrating an example of route display according to the fifth modification. In the example of FIG. 23, the terminal apparatus 40 displays the route display generated on the basis of the information of the radio field intensity of each of the plurality of cells on the AR space. An outlined arrow in the drawing indicates route display.

Note that the heat map (for example, the heat map illustrated in FIG. 22) to which the route display is added may be generated by the server 10 or may be generated by the terminal apparatus 40. In addition, the terminal apparatus 40 may acquire the heat map to which the route display is not added from the server 10 and add the route display to the acquired heat map.

### 4-6. Sixth Modification Related to Output Control

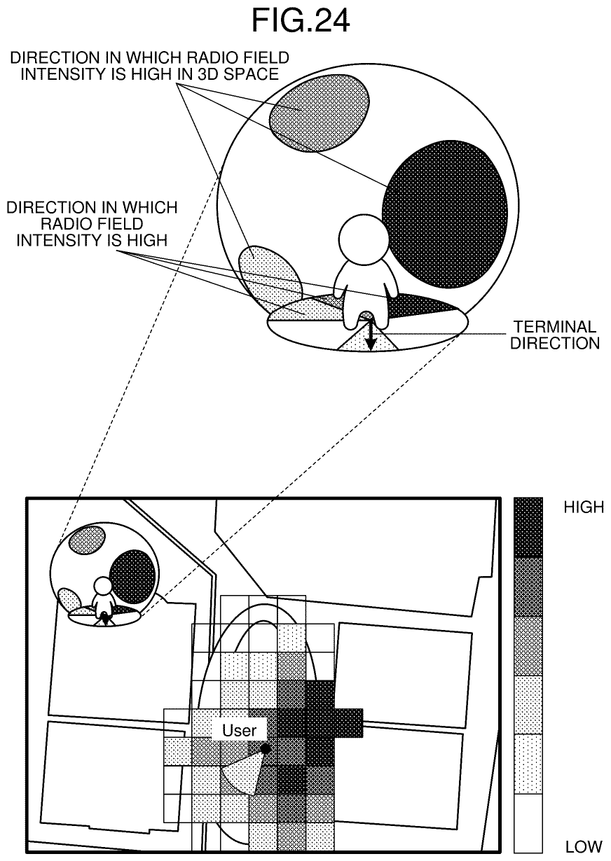

In order to enable the user to obtain detailed information on the radio field intensity information of the surrounding millimeter waves and the direction in which the radio field intensity is strong, the terminal apparatus 40 may add a 3D display stereoscopically indicating the direction in which the radio field intensity is strong to the heat map. FIG. 24 is a diagram illustrating an example of a heat map according to a sixth modification. An enlarged display at the top of the drawing is a 3D display. In the 3D display, in addition to the direction in which the radio field intensity is high in the 3D space, the terminal direction and the direction in which the radio field intensity is high in the 2D space are also displayed. The 3D display may be rotatable in a planar direction by a user operation.

Note that the heat map (for example, the heat map illustrated in FIG. 24) to which the 3D display is added may be generated by the server 10 or may be generated by the terminal apparatus 40. Furthermore, the terminal apparatus 40 may acquire the heat map to which the 3D display is not added from the server 10 and add the 3D display to the acquired heat map.

### 4-7. Seventh Modification Related to Output Control

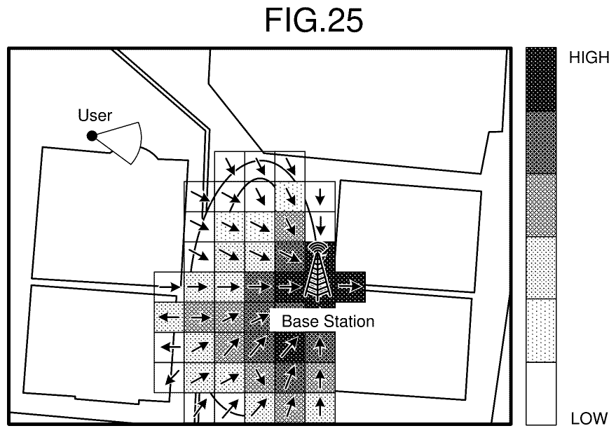

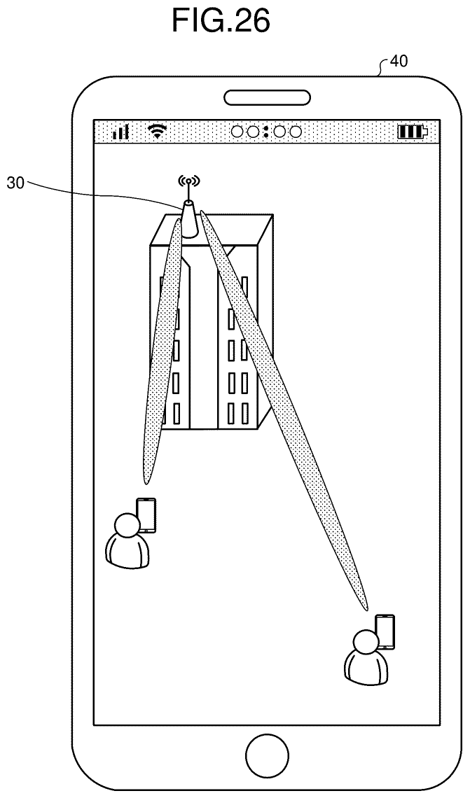

The terminal apparatus 40 may output, to the output unit 45, a display indicating the position of the base station 30 estimated on the basis of the transmission power information from the base station 30. FIG. 25 is a diagram illustrating an example of a heat map according to a seventh modification. The terminal apparatus 40 acquires transmission power information from the base station 30, and estimates the position of the base station 30 on the basis of the transmission power information. Then, the terminal apparatus 40 adds a display indicating the position of the base station 30 to the heat map.

The terminal apparatus 40 may display the position of the base station 30 on the 3D map. FIG. 26 is a diagram illustrating an example of base station position display according to the seventh modification. In addition, the terminal apparatus 40 may display the position of the base station 30 on the 2D map. Note that the terminal apparatus 40 may also display the position of the base station 30 to which the terminal apparatus 40 has not been connected on the map.

As a result, the user can grasp the antenna direction of the base station together with the current location of the user. As a result, the terminal apparatus 40 can assist the operation of improving the communication quality of the user.

Note that the map (for example, the map illustrated in FIGS. 25 and 26) to which the base station position indication is added may be generated by the server 10 or may be generated by the terminal apparatus 40. In addition, the terminal apparatus 40 may acquire a map to which the base station position indication is not added from the server 10 and add the base station position indication to the acquired map.

### 4-8. Other Modifications

In the above-described embodiment, the heat map is generated by the server 10, but the heat map may be generated by the terminal apparatus 40. In addition, the heat map may be generated by the management apparatus 20 or may be generated by the base station 30.

Furthermore, in the above-described embodiment, the predetermined frequency band is a frequency band included in the quasi-millimeter wave band and the millimeter wave band, but the predetermined frequency band may include a frequency band other than the quasi-millimeter wave band and the millimeter wave band. For example, the predetermined frequency band may be a frequency band included in a submillimeter wave (300 to 3000 GHz band) or a frequency band of a submillimeter wave (300 to 3000 GHz band) or more (for example, a frequency band used in optical wireless communication).

The control apparatus that controls the server 10, the management apparatus 20, the base station 30, or the terminal apparatus 40 of the present embodiment may be realized by a dedicated computer system or a general-purpose computer system.

For example, a communication program for executing the above-described operation is stored and distributed in a computer-readable recording medium such as an optical disk, a semiconductor memory, a magnetic tape, or a flexible disk. Then, for example, the program is installed in a computer, and the above-described processing is executed to configure the control apparatus. At this time, the control apparatus may be an apparatus (for example, a personal computer) outside the server 10, the management apparatus 20, the base station 30, or the terminal apparatus 40. Furthermore, the control apparatus may be an apparatus (for example, the control unit 13, the control unit 23, the control unit 33, or the control unit 43) inside the server 10, the management apparatus 20, the base station 30, or the terminal apparatus 40.

In addition, the above-described communication program may be stored in a disk apparatus included in a server on a network such as the Internet so that the communication program can be downloaded to a computer. In addition, the above-described functions may be realized by cooperation of an operating system (OS) and application software. In this case, a portion other than the OS may be stored in a medium and distributed, or a portion other than the OS may be stored in a server and downloaded to a computer or the like.

In addition, among the processes described in the above embodiments, all or a part of the processes described as being performed automatically can be performed manually, or all or a part of the processes described as being performed manually can be performed automatically by a known method. In addition, the processing procedures, specific names, and information including various data and parameters illustrated in the above-described document and the drawings can be arbitrarily changed unless otherwise specified. For example, the various types of information illustrated in each figure are not limited to the illustrated information.

In addition, each component of each apparatus illustrated in the drawings is functionally conceptual, and is not necessarily physically configured as illustrated in the drawings. That is, a specific form of distribution and integration of each apparatus is not limited to the illustrated form, and all or a part thereof can be functionally or physically distributed and integrated in an arbitrary unit according to various loads, usage conditions, and the like. Note that this configuration by distribution and integration may be performed dynamically.

In addition, the above-described embodiments can be appropriately combined in an area in which the processing contents do not contradict each other. Furthermore, the order of each step illustrated in the flowchart of the above-described embodiments can be appropriately changed.

Furthermore, for example, the present embodiment can be implemented as any configuration constituting an apparatus or a system, for example, a processor as a system large scale integration (LSI) or the like, a module using a plurality of processors or the like, a unit using a plurality of modules or the like, a set obtained by further adding other functions to a unit, or the like (that is, a configuration of a part of the apparatus).

Note that, in the present embodiment, the system means a set of a plurality of components (apparatuses, modules (parts), or the like), and it does not matter whether or not all the components are in the same housing. Therefore, a plurality of apparatuses housed in separate housings and connected via a network and one apparatus in which a plurality of modules is housed in one housing are both systems.

Furthermore, for example, the present embodiment can adopt a configuration of cloud computing in which one function is shared and processed by a plurality of apparatuses in cooperation via a network.

### 5. CONCLUSION

As described above, according to an embodiment of the present disclosure, the information processing apparatus (the server 10 or the terminal apparatus 40) performs control to acquire information on a geographical position, and output, to the output unit 45 of the terminal apparatus 40, direction information indicating a direction in which radio field intensity increases in a case where the terminal apparatus 40 performs wireless connection using a predetermined frequency band at the geographical position. The direction information is information calculated on the basis of information regarding wireless connection collected from a plurality of terminal apparatuses 40 within a predetermined area selected on the basis a geographical position. At this point, the information regarding the wireless connection includes at least information about the radio field intensity and the terminal direction when each of the plurality of terminal apparatuses 40 performs the wireless connection using the predetermined frequency band.

As a result, the user can determine at which position and in which direction the terminal apparatus 40 should be directed without prior measurement by the terminal apparatus 40 during wireless communication using a high frequency band. As a result, the information processing apparatus (the server 10 or the terminal apparatus 40) can realize wireless communication of high communication quality.

Although the embodiments of the present disclosure have been described above, the technical scope of the present disclosure is not limited to the above-described embodiments as it is, and various modifications can be made without departing from the gist of the present disclosure. In addition, components of different embodiments and modifications may be appropriately combined.

Furthermore, the effects of each embodiment described in the present specification are merely examples and are not limited, and other effects may be provided.

Note that the present technology can also have the following configurations.

(1)

An information processing apparatus comprising:
an acquisition unit that acquires information of a geographical position; and
an output control unit that outputs direction information indicating a direction in which radio field intensity increases in a case where wireless connection using a predetermined frequency band is performed at the geographical position.
   (2)

The information processing apparatus according to (1), wherein
the output control unit outputs the direction information for each of a plurality of areas set on a basis of the geographical position.
   (3)

The information processing apparatus according to (2), wherein
the output control unit outputs area display of each of the plurality of areas on a map and adds a display indicating the direction information to each area display on the map.
   (4)

The information processing apparatus according to (3), wherein
the output control unit adds a display indicating the direction information and the radio field intensity to each area display on the map.
   (5)

The information processing apparatus according to (3), wherein
the information processing apparatus is a terminal apparatus capable of the wireless connection using the predetermined frequency band.
   (6)

The information processing apparatus according to (5), wherein
the output control unit superimposes and displays information indicating terminal directions and radio field intensities of other terminal apparatuses currently performing the wireless connection using the predetermined frequency band on the map.
   (7)

The information processing apparatus according to (6), wherein
the output control unit superimposes and displays information indicating terminal directions and radio field intensities of other terminal apparatuses that have performed the wireless connection using the predetermined frequency band on the map during a predetermined period in a past.
   (8)

The information processing apparatus according to any one of (5) to (7), wherein
the output control unit superimposes and displays the direction information calculated for each weather on the map.
   (9)

The information processing apparatus according to any one of (5) to (8), wherein
the output control unit hides the area display of a predetermined radio field intensity on a basis of an operation of a user.
   (10)

The information processing apparatus according to any one of (5) to (9), wherein
the output control unit hides the area display of an inaccessible area.
   (11)

The information processing apparatus according to any one of (5) to (10), wherein
the output control unit outputs the area display of each of a plurality of areas selected on a basis of a current terminal direction of the terminal apparatus on the map.
   (12)

The information processing apparatus according to any one of (5) to (11), wherein
the output control unit outputs a route display generated on a basis of information of radio field intensity of each of the plurality of areas.
   (13)

The information processing apparatus according to any one of (5) to (12), wherein
the output control unit adds a 3D display stereoscopically indicating a direction in which the radio field intensity is high to the map.
   (14)

The information processing apparatus according to any one of (5) to (13), wherein
the output control unit outputs a display indicating a position of a base station estimated on a basis of transmission power information from the base station.
   (15)

The information processing apparatus according to any one of (1) to (14), wherein
the direction information is information calculated on a basis of information regarding wireless connection collected from a plurality of terminal apparatuses in a predetermined area selected on a basis of the geographical position, and
the information regarding the wireless connection includes at least information about radio field intensity and a terminal direction when each of the plurality of terminal apparatuses performs the wireless connection using the predetermined frequency band.
   (16)

The information processing apparatus according to any one of (1) to (15), wherein
the predetermined frequency band is a frequency band included in a millimeter wave band and a quasi-millimeter wave band.
   (17)

An information processing apparatus comprising:
an acquisition unit that acquires information of a geographical position; and
a calculation unit that calculates direction information indicating a direction in which radio field intensity increases in a case where wireless connection using a predetermined frequency band is performed at the geographical position, wherein
the direction information is information calculated on a basis of information regarding wireless connection collected from a plurality of terminal apparatuses in a predetermined area selected on a basis of the geographical position, and
the information regarding the wireless connection includes at least information about radio field intensity and a terminal direction when each of the plurality of terminal apparatuses performs the wireless connection using the predetermined frequency band.
   (18)

The information processing apparatus according to (17), wherein
the calculation unit calculates the direction information by repeatedly executing processing of calculating a radio field intensity in a reference direction on a basis of the information regarding the wireless connection selected on a basis of the terminal direction while shifting the reference direction.
   (19)

An information processing method comprising:
an acquiring step of acquiring information of a geographical position; and
an output control step of outputting direction information indicating a direction in which wireless connection is facilitated at the geographical position.
   (20)

An information processing method comprising:
an acquiring step of acquiring information of a geographical position; and
a calculation step of calculating direction information indicating a direction in which radio field intensity increases in a case where wireless connection using a predetermined frequency band is performed at the geographical position, wherein
the direction information is information calculated on a basis of information regarding wireless connection collected from a plurality of terminal apparatuses in a predetermined area selected on a basis of the geographical position, and
the information regarding the wireless connection includes at least information about radio field intensity and a terminal direction when each of the plurality of terminal apparatuses performs the wireless connection using the predetermined frequency band.

### REFERENCE SIGNS LIST

1 COMMUNICATION SYSTEM
10 SERVER
20 MANAGEMENT APPARATUS
30 BASE STATION
40 TERMINAL APPARATUS
11, 2 COMMUNICATION UNIT
31, 41 WIRELESS COMMUNICATION UNIT
12, 22, 32, 42 STORAGE UNIT
13, 23, 33, 43 CONTROL UNIT
44 INPUT UNIT
45 OUTPUT UNIT
131, 431 ACQUISITION UNIT
132, 432 CALCULATION UNIT
133, 433 OUTPUT CONTROL UNIT
311, 411 TRANSMISSION PROCESSING UNIT
312, 412 RECEPTION PROCESSING UNIT
313, 413 ANTENNA
N1, N2 NETWORK

1. An information processing apparatus comprising:
an acquisition unit that acquires information of a geographical position; and
an output control unit that outputs direction information indicating a direction in which radio field intensity increases in a case where wireless connection using a predetermined frequency band is performed at the geographical position.

2. The information processing apparatus according to claim 1, wherein
the output control unit outputs the direction information for each of a plurality of areas set on a basis of the geographical position.

3. The information processing apparatus according to claim 2, wherein
the output control unit outputs area display of each of the plurality of areas on a map and adds a display indicating the direction information to each area display on the map.

4. The information processing apparatus according to claim 3, wherein
the output control unit adds a display indicating the direction information and the radio field intensity to each area display on the map.

5. The information processing apparatus according to claim 3, wherein
the information processing apparatus is a terminal apparatus capable of the wireless connection using the predetermined frequency band.

6. The information processing apparatus according to claim 5, wherein
the output control unit superimposes and displays information indicating terminal directions and radio field intensities of other terminal apparatuses currently performing the wireless connection using the predetermined frequency band on the map.

7. The information processing apparatus according to claim 6, wherein
the output control unit superimposes and displays information indicating terminal directions and radio field intensities of other terminal apparatuses that have performed the wireless connection using the predetermined frequency band on the map during a predetermined period in a past.

8. The information processing apparatus according to claim 5, wherein
the output control unit superimposes and displays the direction information calculated for each weather on the map.

9. The information processing apparatus according to claim 5, wherein
the output control unit hides the area display of a predetermined radio field intensity on a basis of an operation of a user.

10. The information processing apparatus according to claim 5, wherein
the output control unit hides the area display of an inaccessible area.

11. The information processing apparatus according to claim 5, wherein
the output control unit outputs the area display of each of a plurality of areas selected on a basis of a current terminal direction of the terminal apparatus on the map.

12. The information processing apparatus according to claim 5, wherein
the output control unit outputs a route display generated on a basis of information of radio field intensity of each of the plurality of areas.

13. The information processing apparatus according to claim 5, wherein
the output control unit adds a 3D display stereoscopically indicating a direction in which the radio field intensity is high to the map.

14. The information processing apparatus according to claim 5, wherein
the output control unit outputs a display indicating a position of a base station estimated on a basis of transmission power information from the base station.

15. The information processing apparatus according to claim 1, wherein
the direction information is information calculated on a basis of information regarding wireless connection collected from a plurality of terminal apparatuses in a predetermined area selected on a basis of the geographical position, and
the information regarding the wireless connection includes at least information about radio field intensity and a terminal direction when each of the plurality of terminal apparatuses performs the wireless connection using the predetermined frequency band.

16. The information processing apparatus according to claim 1, wherein
the predetermined frequency band is a frequency band included in a millimeter wave band and a quasi-millimeter wave band.

17. An information processing apparatus comprising:
an acquisition unit that acquires information of a geographical position; and
a calculation unit that calculates direction information indicating a direction in which radio field intensity increases in a case where wireless connection using a predetermined frequency band is performed at the geographical position, wherein
the direction information is information calculated on a basis of information regarding wireless connection collected from a plurality of terminal apparatuses in a predetermined area selected on a basis of the geographical position, and
the information regarding the wireless connection includes at least information about radio field intensity and a terminal direction when each of the plurality of terminal apparatuses performs the wireless connection using the predetermined frequency band.

18. The information processing apparatus according to claim 17, wherein
the calculation unit calculates the direction information by repeatedly executing processing of calculating a radio field intensity in a reference direction on a basis of the information regarding the wireless connection selected on a basis of the terminal direction while shifting the reference direction.

19. An information processing method comprising:
an acquiring step of acquiring information of a geographical position; and
an output control step of outputting direction information indicating a direction in which wireless connection is facilitated at the geographical position.

20. An information processing method comprising:
an acquiring step of acquiring information of a geographical position; and
a calculation step of calculating direction information indicating a direction in which radio field intensity increases in a case where wireless connection using a predetermined frequency band is performed at the geographical position, wherein
the direction information is information calculated on a basis of information regarding wireless connection collected from a plurality of terminal apparatuses in a predetermined area selected on a basis of the geographical position, and
the information regarding the wireless connection includes at least information about radio field intensity and a terminal direction when each of the plurality of terminal apparatuses performs the wireless connection using the predetermined frequency band.
